(19) United States
(12) Patent Application Publication
(10) Pub. No.: US 2022/0035864 A1
(43) Pub. Date: Feb. 3, 2022

(54) SYSTEM AND METHOD OF INTELLIGENT PROFILING A USER OF A CLOUD-NATIVE APPLICATION DEVELOPMENT PLATFORM

(71) Applicant: BOOMI, INC., Round Rock, TX (US)

(72) Inventors: Michael J. Morton, Morrisville, NC (US); Daniel Schwartz, Marlton, NJ (US)

(73) Assignee: BOOMI, INC., Round Rock, TX (US)

(21) Appl. No.: 16/943,656

(22) Filed: Jul. 30, 2020

(51) Int. Cl. G06F 16/9035; G06F 16/907; G06F 40/205; G06F 40/284; G06K 9/00

(52) U.S. Cl. CPC G06F 16/9035; G06F 16/907; G06K 9/00449; G06F 40/284; G06F 40/205

(57) ABSTRACT

An information handling system operating an integration application development platform user profiling module may include a processor; a memory; a network interface device receiving a plurality of integration application development platform operation logs recording metadata for tracking selections of integration process visual elements of an application development platform by a plurality of users for developing business integration processes; and an integration application development platform user profiling module to, upon execution by the processor, create an integration application user profile associated with each of the plurality of users created using the metadata; wherein each of the integration application user profiles are created based on metadata descriptive of: each individual user's experience with the application development platform used for matching individual users, and each individual user's determined skill level in developing the business integration processes.

### FIELD OF THE DISCLOSURE

The present disclosure relates generally to a system and method for deploying and executing customized data integration processes. More specifically, the present disclosure relates to the tracking of the development of a business integration model using visual elements, viewable as visual elements on a graphical user interface, as they are manipulated during a customized application development process by a user and, using data related to the visual elements, defining a user profile of the user.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), a head-mounted display device, server (e.g., blade server or rack server), a network storage device, a network storage device, a switch router or other network communication device, other consumer electronic devices, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. Further, the information handling system may include telecommunication, network communication, and video communication capabilities and require communication among a variety of data formats.

### BRIEF DESCRIPTION OF THE DRAWINGS

The present disclosure will now be described by way of example with reference to the following drawings in which:

FIG. 1 is a block diagram illustrating an information handling system according to an embodiment of the present disclosure;

FIG. 2 is a block diagram illustrating a simplified integration network according to an embodiment of the present disclosure;

FIG. 3A is a graphical diagram illustrating a user-generated flow diagram of a business integration process via a business integration application management system according to an embodiment of the present disclosure;

FIG. 3B is a graphical diagram illustrating a user-generated flow diagram of a business integration process via a business integration application management system according to another embodiment of the present disclosure;

FIG. 4 is a graphical diagram illustrating a plurality of user-generated flow diagrams produced for a plurality of users according to an embodiment of the present disclosure;

FIG. 5 is a graphical diagram illustrating a user-generated flow diagram of a business integration process via a business integration application management system according to an embodiment of the present disclosure;

FIG. 6 is a graphical diagram illustrating a user/visual element interaction matrix with business integration application management systems according to an embodiment of the present disclosure;

FIG. 7 is a graphical diagram illustrating mapping between multiple data model fieldnames for a single data model field value throughout an integration process according to an embodiment of the present disclosure;

FIG. 8 is a flow diagram illustrating a method of creating a profile of a user of an integration application development platform for a business integration application management system according to an embodiment of the present disclosure; and

FIG. 9 is a flow diagram illustrating a method of connecting a first user with another user within an integration application development platform community collaboration system according to an embodiment of the present disclosure.

The use of the same reference symbols in different drawings may indicate similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Conventional software development and distribution models have involved development of an executable software application, and distribution of a computer-readable medium, or distribution via download of the application from the worldwide web to an end user. Upon receipt of the downloaded application, the end user executes installation files to install the executable software application on the user's personal computer (PC), or other information handling system. When the software is initially executed, the application may be further configured/customized to recognize or accept input relating to aspects of the user's PC, network, etc., to provide a software application that is customized for a particular user's computing system. This simple, traditional approach has been used in a variety of contexts, with software for performing a broad range of different functionality. While this model might sometimes be satisfactory for individual end users, it is undesirable in sophisticated computing environments.

Today, most corporations or other enterprises have sophisticated computing systems that are used both for internal operations, and for communicating outside the enterprise's network. Much of present-day information exchange is conducted electronically, via communications networks, both internally to the enterprise, and among enterprises. Accordingly, it is often desirable or necessary to exchange information/data between distinctly different computing systems, computer networks, software applications, etc. In many instances, these disparate computing networks, enterprises, or systems are located in a variety of different countries around the world. The enabling of communications between diverse systems/networks/applications in connection with the conducting of business processes is often referred to as “business process integration.” In the business process integration context, there is a significant need to communicate between different software applications/systems within a single computing network, e.g. between an enterprise's information warehouse management system and the same enterprise's purchase order processing system. There is also a significant need to communicate between different software applications/systems within different computing networks, e.g. between a buyer's purchase order processing system, and a seller's invoicing system. Some of these different software applications/systems may be cloud-based, with physical servers located in several different countries, cities, or other geographical locations around the world. As data is integrated between and among these cloud-based platforms, datasets may be stored (e.g., temporarily or indefinitely) in some form at physical servers in these various geographical locations.

Relatively recently, systems have been established to enable exchange of data via the Internet, e.g. via web-based interfaces for business-to-business and business-to-consumer transactions. For example, a buyer may operate a PC to connect to a seller's website to provide manual data input to a web interface of the seller's computing system, or in higher volume environments, a buyer may use an executable software application known as EDI Software, or Business-to-Business Integration Software to connect to the seller's computing system and to deliver electronically a business “document,” such as a purchase order, without requiring human intervention to manually enter the data. Such software applications are available in the market today. These applications are typically purchased from software vendors and installed on a computerized system owned and maintained by the business, in this example, the buyer. The seller will have a similar/complementary software application on its system, so that the information exchange may be completely automated in both directions. In contrast to the present disclosure, these applications are purchased, installed and operated on the user's local system. Thus, the user typically owns and maintains its own copy of the system, and configures the application locally to connect with its trading partners.

In both the traditional and more recent approaches, the executable software application is universal or “generic” as to all trading partners before it is received and installed within a specific enterprise's computing network. In other words, it is delivered to different users/systems in identical, generic form. The software application is then installed within a specific enterprise's computing network (which may include data centers, etc., physically located outside of an enterprises' physical boundaries). After the generic application is installed, it is then configured and customized for a specific trading partner after which it is ready for execution to exchange data between the specific trading partner and the enterprise. For example, Walmart® may provide on its website specifications of how electronic data such as Purchase Orders and Invoices must be formatted for electronic data communication with Walmart®, and how that data should be communicated with Walmart®. A supplier/enterprise is then responsible for finding a generic, commercially available software product that will comply with these communication requirements and configuring it appropriately. Accordingly, the software application will not be customized for any specific supplier until after that supplier downloads the software application to its computing network and configures the software application for the specific supplier's computing network, etc. Alternatively, the supplier may engage computer programmers to create a customized software application to meet these requirements, which is often exceptionally time-consuming and expensive.

Recently, systems and software applications have been established to provide a system and method for on-demand creation of customized software applications in which the customization occurs outside of an enterprise's computing network. These software applications are customized for a specific enterprise before they arrive within the enterprise's computing network, and are delivered to the destination network in customized form. The Dell Boomi® Application is an example of one such software application. In some embodiments described herein, these types of applications may be described as a business integration application management system forming part of or associated with an information handling system. With Dell Boomi®, or other system that includes a business integration application management system having an integration application development platform, an employee within an enterprise can connect to a website using a specially configured graphical user interface to visually model a business integration process via a flowcharting process, using only a web browser interface. During such a modeling process, the user would select from a predetermined set of process-representing visual elements that are stored on a remote server, such as the web server. By way of an example, the integration process could enable a bi-directional exchange of data between internal applications of an enterprise, between internal enterprise applications and external trading partners, or between internal enterprise applications and applications running external to the enterprise.

A business integration application management system with an integration application development platform in an embodiment may allow a user to create a customized data integration software application by modeling a data integration process flow using a visual user interface. A modeled data integration process flow in embodiments of the present disclosure may model actions taken on data elements pursuant to executable code instructions without displaying the code instructions themselves. In such a way, the visual user interface may allow a user to understand the high-level summary of what executable code instructions achieve, without having to read or understand the code instructions themselves. Similarly, by allowing a user to insert visual elements representing portions of an integration process into the modeled data integration process flow displayed on the visual user interface, embodiments of the present disclosure allow a user to identify what the user wants executable code instructions to achieve without having to write such executable code instructions.

Once a user has chosen what the user wants an executable code instruction to achieve in embodiments herein, the code instructions capable of achieving such a task may be generated. Code instructions for achieving a task can be written in any number of languages and/or adhere to any number of standards, often requiring a code writer to have extensive knowledge of computer science and languages. The advent of open-standard formats for writing code instructions that are both human-readable and machine executable have made the writing of code instructions accessible to individuals that do not have a high-level knowledge of computer science. Such open-standard, human-readable, data structure formats include extensible markup language (XML) and JavaScript Object Notification (JSON). Because code instructions adhering to these open-standard formats are more easily understood by non-specialists, many companies have moved to the use of code instructions adhering to these formats in constructing their data repository structures and controlling the ways in which data in these repositories may be accessed by both internal and external agents. In order to execute code instructions for accessing data at such a repository during a business integration process, the code instructions of the business integration process in some embodiments herein may be written in accordance with the same open-standard formats or other known, or later-developed standard formats.

In addition to the advent of open-standard, human-readable, machine-executable code instructions, the advent of application programming interfaces (APIs) designed using such open-standard code instructions have also streamlined the methods of communication between various software components. An API may operate to communicate with a backend application to identify an action to be taken on a dataset that the backend application manages, or which is being transmitted for management to the backend application. Such an action and convention for identifying the dataset or its location may vary among APIs and their backend applications. For example, datasets may be modeled according to user-supplied definitions. Each dataset may contain a user-defined data model fieldname, which may describe a type of information. Each user-defined data model fieldname may be associated with a data model field value. In other words, datasets may be modeled using a fieldname:value pairing. For example, a data model for a customer named John Smith may include a first data model fieldname “f_name” paired with a first data model field value “John,” and a second data model fieldname “I_name” paired with a second data model field value “Smith.” A user in an embodiment may define any number of such data model fieldname/value pairs to describe a user. Other example data model fieldnames in embodiments may include “dob” to describe date of birth, “ssn” to describe social security number, “phone” to describe a phone number, “hair” to describe a hair color, “race” to describe a race, or “reward” to describe a reward, among other fieldnames.

In embodiments described herein, multiple APIs or backend applications accessed via a single integration process may operate according to differing coding languages, data model structures, data model field naming conventions or standards. Different coding languages may use different ways of describing routines, data structures, object classes, variables, or remote calls that may be invoked and/or handled during business integration processes that involve data model field values managed by the backend applications such APIs serve. Thus, a single data model field value may be described in a single integration process using a plurality of data model fieldnames, each adhering to the naming conventions set by the APIs, applications, enterprises, or trading partners through or among which the data model field value is programmed to integrate.

A user interacting with such an API for a backend application may identify such data model field values based on a description that may or may not include the actual data model fieldname of the data model field value. In some circumstances, a data model field value may be identified through a search mechanism, or through navigation through a variety of menus, for example. The code sets incorporating the actual data model fieldname for the data model field value may be automatically generating based on this user interaction with an API. In other embodiments, the data model field value may be identified in a similar way through interaction with the visual integration process flow user interface described herein. For example, the user may create two or more connector visual elements, with each connector element representing a process taken by a different application (e.g., Salesforce®, or NetSuite®). Because each of such connector elements may describe actions taken by a different application, and different applications may adhere to differing code languages, each of a plurality of code sets generated based on these user-generated connector visual elements may be written in a different code set, and may identify data model field values using different naming conventions, or storage structures. Thus, the code instructions for retrieving a given data model field value from a first application may describe that data model field value using a completely different data model fieldname than the code instructions for transmitting the same data model field value to a second application.

In embodiments described herein, a runtime engine may be created for execution of each of these code instructions written based on the user-modeled business integration process. The runtime engine, and all associated code instructions or code sets may be transmitted to an end user for execution at the user's computing device, or enterprise system, and potentially, behind the user's firewall. Because the user does not write the code instructions executed by the runtime engine, the user may not know the locations of servers through which the data to be integrated may pass during execution of the runtime engine, or the ways in which data model field values may be transformed (e.g., given a different data model fieldname) therein. As described above, the data model field values integrated during execution may pass through any number of servers, which may be located in various locations around the world.

In addition to the use of APIs and the business integration application management system, the information handling system may include an integration application development platform user profiling module. The integration application development platform user profiling module may form part of the business integration application management system of the information handling system. During operation of the information handling system, a network interface device receives a plurality of integration application development platform operation logs recording metadata for tracking selections of integration process visual elements by a plurality of users for developing integration processes. The integration application development platform user profiling module may then, upon execution of a processor, create a user profile associated with each of the plurality of users created using the metadata. The metadata may be descriptive of each individual user's experience with a business integration application management system with an integration application development platform; each individual user's skill level in developing the integration processes; each individual user's experience in an industry the integration processes are developed to operate within; and each individual user's physical location, among others. In an embodiment, the created user profiles may be used to connect the plurality of users together on a community forum associated with the business integration application management system.

In some embodiments, the business integration application management system may receive or monitor for posts or questions presented on the community forum from any individual user. The business integration application management system may then receive this input from the network interface device and parse the post or question to find key words within the post or question. Based on the parsed words found in the post or question, the business integration application management system may direct the question to a separate user whose user profile indicates that, in some embodiments, the separate user may be able to help the first user with. By way of an example, the business integration application management system may have parsed the post or question and concluded that the first user is requesting help with the development of an integration process associated with a specific industry such as the healthcare industry. The business integration application management system may then match the first user with a separate user whose user profile indicates that the separate user has developed an integration process associated with the healthcare industry. In alternative embodiments, the linking of the first user with the second user may be based on which visual elements, representing processes within the integration process, the first user is seeking help with and which of the separate users has had sufficient experience with creating an integration process that implements those specific visual elements. Other key words may be parsed in the question or post from the first user in order to direct that questions or post to a separate user based on the user profile created by the integration application development platform user profiling module for the separate user.

In some embodiments, the metadata descriptive of the individual user's experience with a business integration application management system with an integration application development platform includes metadata descriptive of which business integration application management system with an integration application development platform, among a plurality of different business integration application management system with an integration application development platform, the individual user's select to develop the integration processes. Example business integration application management system with an integration application development platform may include QuickBooks, SalesForce's® Customer Relationship Management (CRM) Platform, Oracle's® Netsuite Enterprise Resource Planning (ERP) Platform, Infor's® Warehouse Management Software (WMS) Application, Zuora's® SaaS business account applications, Amazon's® web services, Taleo's® Talent-Management Software, among others.

Alternative or additionally, the metadata descriptive of the individual user's experience with a business integration application management system with an integration application development platform includes metadata descriptive of a data mapping composition related to the business integration application management system with an integration application development platform the individual user's select to develop the integration processes. In some embodiments, the integration application development platform user profiling module may engage in data mapping, for example, data model fieldnames related to a given data model field value that is associated with the visual elements (representative of process components of the integration process) within the integration process. The data model fieldnames are present throughout an integration process and the business integration application management system may identify which of data model fieldnames was applied at each visual element/application/location/enterprise involved in the integration process as well as the manipulation or action performed by each of these visual elements/applications/locations/enterprises during the integration process. As such, users of the visual user interface describing the flow of the integration process described herein may use map elements to associate a first data model fieldname for a data model field value being retrieved from a first application or source with a second data model fieldname under which that data model field value will be stored at a second application or destination.

In an embodiment, the metadata descriptive of the individual user's skill level includes metadata descriptive of the number of integration process visual elements used by the individual users to develop the integration processes. As described herein, some users of the integration may use or may have only used a specific subset of visual elements (representative of visual elements of the integration process) provided or available to them by the business integration application management system. However, what visual elements are being used by the user, the integration application development platform user profiling module concludes that the user has skills associated with those visual elements. In this embodiment, the business integration application management system and/or the integration application development platform user profiling module may direct any questions or posts related to those other users who have implemented these visual elements to answer questions the user may have regarding their use. Again, this may be done within an online community forum associated with the business integration application management system.

In an embodiment, the metadata descriptive of the individual user's skill level includes metadata descriptive of the variety of integration process visual elements used by the individual users to develop the integration processes. Similar to the number of integration process visual elements being used to create the user profile, the variety of those used visual elements may also provide metadata to the business integration application management system to determine any given user's skill level with those visual elements.

In an embodiment, the metadata descriptive of the individual user's experience in an industry includes metadata associated with descriptive words the individual users associate with the integration process visual elements used by the individual users to develop the integration processes. In an embodiment, a business integration application management system may search code instructions for one or more integration processes to identify data model field values accessed, copied, transferred, or otherwise manipulated therein. Upon identification of a data model field values designed to identify information to be presented during execution of an integration process, the data business integration application management system may label the identified data model field value using one or more of a plurality of labels. For example, information in some embodiments may receive a label identifying a data model field value as falling within one of a plurality of types of information, including personal data, sensitive data, security data, health data, financial data, identification data, or national data. Individual data records within data model field values may be labeled as one of these categories based on a description stored in metadata (e.g., documents marked confidential), or within the data model fieldname for the data (e.g., data model field value having a data model fieldname that includes search terms such as “FirstName,” or “SSN” for Social Security Number). Thus, by searching code instructions including data model fieldnames and metadata of data model field values accessed, copied, transferred, or otherwise manipulated throughout an integration process, the business integration application management system in an embodiment may assist the integration application development platform user profiling module in developing a profile of the user.

In an embodiment, the metadata descriptive of the individual user's experience in an industry includes metadata associated with XML files associated with the integration process visual elements used by the individual users to develop the integration processes. Similar to the includes metadata associated with descriptive words the individual users associate with the integration process visual elements, the XML, files associated with the visual elements may be used to develop a user profile for each of a plurality of users operating the business integration application management system as described herein.

After a user has implemented the business integration application management system at the graphical user interface of the information handling system and the profile for the user has been developed, this profile is used to notify other users of the plurality of users that a user may require guidance in developing or further developing the integration process. In an embodiment, the user profile of this first user is matched with a similar user profile associated with a second user so that the first and second user may be connected over a community forum to discuss how to best create the integration process.

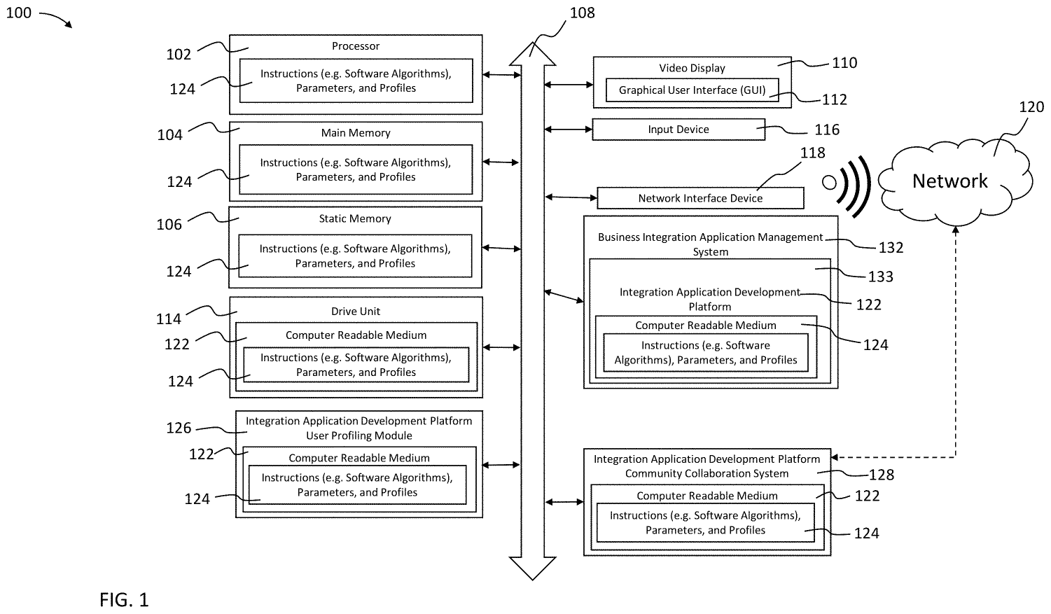

Turning now to the figures, FIG. 1 is a block diagram illustrating an information handling system, according to an embodiment of the present disclosure. Information handling system 100 can include processing resources for executing machine-executable code, such as a central processing unit (CPU), a programmable logic array (PLA), an embedded device such as a System-on-a-Chip (SoC), or other control logic hardware used in an information handling system several examples of which are described herein. The information handling system 100 can also include one or more computer-readable media for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include devices or modules that embody one or more of the devices or execute instructions for the one or more systems and modules herein, and operates to perform one or more of the methods. The information handling system 100 may execute code 124 for the integration application development platform user profiling module 126, the business integration application management system 132 with an integration application development platform 133, or the integration application development platform community collaboration system 128 that may operate on servers or systems, remote data centers, or on-box in individual client information handling systems such as a local display device, or a remote display device, according to various embodiments herein. In some embodiments, it is understood any or all portions of code 124 for the integration application development platform user profiling module 126, the business integration application management system 132 with an integration application development platform 133, or the integration application development platform community collaboration system 128 may operate on a plurality of information handling systems 100.

The information handling system 100 may include a processor 102 such as a central processing unit (CPU), a graphics-processing unit (GPU), control logic or some combination of the same. Any of the processing resources may operate to execute code that is either firmware or software code. Moreover, the information handling system 100 can include memory such as main memory 104, static memory 106, drive unit 114, or the computer readable medium 122 of the integration application development platform user profiling module 126, the business integration application management system 132 with an integration application development platform 133, or the integration application development platform community collaboration system 128 (volatile (e.g. random-access memory, etc.), nonvolatile (read-only memory, flash memory etc.) or any combination thereof). Additional components of the information handling system can include one or more storage devices such as static memory 106, drive unit 114, and the computer readable medium 122 of the integration application development platform user profiling module 126, the business integration application management system 132 with an integration application development platform 133, or the integration application development platform community collaboration system 128. The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a video display 110, such as a liquid crystal display (LCD), an organic light emitting diode (OLED), a flat panel display, a solid state display, or other display device. Additionally, the information handling system 100 may include an input device 116, such as an alpha numeric control device, a keyboard, a mouse, touchpad, fingerprint scanner, retinal scanner, face recognition device, voice recognition device, or gesture or touch screen input.

The information handling system 100 may further include a graphical user interface (GUI) 112. The GUI 112 in an embodiment may provide a visual designer environment permitting a user to define process flows between applications/systems, such as between trading partner and enterprise systems, and to model a customized business integration process. The GUI 112 in an embodiment may provide a menu of pre-defined user-selectable visual elements and permit the user to arrange them as appropriate to model a process and may be displayed on the video display 110 for the business integration application management system 132 with an integration application development platform 133. The elements may include visual, drag-and-drop icons representing specific units of work required as part of the integration process, such as invoking an application-specific connector, transforming data from one format to another, routing data down multiple paths of execution by examining the contents of the data, business logic validation of the data being processed, etc.

Further, the GUI 112 allows the user to provide user input providing information relating to trading partners, activities, enterprise applications, enterprise system attributes, and/or process attributes that are unique to a specific enterprise end-to-end business integration process. For example, the GUI 112 may provide drop down or other user-selectable menu options for identifying trading partners, application connector and process attributes/parameters/settings, etc., and dialog boxes permitting textual entries by the user, such as to describe the format and layout of a particular data set to be sent or received, for example, a Purchase Order. The providing of this input by the user results in the system's receipt of such user-provided information as an integration process data profile code set. In the embodiments described herein, the providing of this input by the user may also contribute to the development of metadata that is used by the integration application development platform user profiling module 126 to create a user profile for the user as well as any other user engaged with the business integration application management system 132 with an integration application development platform 133 to develop an integration process. In specific embodiments, this providing of input by the user may also contribute to the development of metadata used to describe, at least, each individual user's experience with a business integration application management system 132 with an integration application development platform 133, each individual user's skill level in developing the integration processes, each individual user's experience in an industry the integration processes are developed to operate within. In some embodiments, any interaction with the GUI 112 by the user describe herein to develop the integration process produces metadata used by the integration application development platform user profiling module 126 to develop the user profiles.

In some embodiments, the GUI 112 may also allow a user to provide one or more search terms that may be used to identify data model field values affected by one or more integration processes that are likely to include sensitive information. A user in such an embodiment may interact with such a user interface 112 to include or exclude terms used by a data integration protection assistance system of the business integration application management system 132 with an integration application development platform 133, for example, to search code instructions executed during one or more integration processes for potentially sensitive data model field values manipulated therein. In yet another embodiment, a user may employ the GUI 112 to search and view information describing data model field values identified in such a manner as potentially sensitive.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of instructions 124 that can be executed to cause the computer system to perform any one or more of the methods or computer-based functions disclosed herein. For example, information handling system 100 includes one or more application programs 124, and Basic Input/Output System and Firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in static memory 106, drive 114, in a ROM (not illustrated) associated with information handling system 100 or other memory. Other options include application programs and BIOS/FW code sourced from remote locations, for example via a hypervisor or other system, that may be associated with various devices of information handling system 100 partially in memory 104, storage system 106, drive unit 114 or in a storage system (not illustrated) associated with network interface device 118 or any combination thereof. Application programs 124, and BIOS/FW code 124 can each be implemented as single programs, or as separate programs carrying out the various features as described herein. Application program interfaces (APIs) such as WinAPIs (e.g. Win32, Win32s, Win64, and WinCE), or an API adhering to a known open source specification may enable application programs 124 to interact or integrate operations with one another. In an embodiment, the network interface device 118 may receive a plurality of integration application development platform operation logs recording metadata for tracking selections of integration process visual elements by a plurality of users for developing integration processes. As described, the integration application development platform user profiling module 126 may use this metadata to create a user profile associated with each of the plurality of users created.

In an embodiment of the present disclosure, instructions 124 may execute software for identifying, labeling, tracking, and reporting information describing data model field values accessed, transferred, copied, or otherwise manipulated during an integration process, for compliance with governmental regulations. The information handling system 100 may operate as a standalone device or may be connected, such as via a network, to other computer systems or peripheral devices.

In an embodiment of the present disclosure, instructions 124 may execute software for receiving, at the network interface device 118, a plurality of integration application development platform operation logs recording metadata for tracking selections of integration process visual elements by a plurality of users for developing integration processes and, with the processor 102 executing the integration application development platform user profiling module 126, creating a user profile associated with each of the plurality of users created using the metadata. Also, the network interface device 118 may be used to connect to a remotely located integration application development platform community collaboration system 128 to determine user profiles or to connect users determined to have similar or compatible profiles. The information handling system 100 may operate as a standalone device or may be connected, such as via a network, to other computer systems or peripheral devices.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The disk drive unit 114, the business integration application management system 132 with an integration application development platform 133, the integration application development platform user profiling module 126, or the integration application development platform community collaboration system 128 may include a computer-readable medium 122 such as a magnetic disk, or a solid-state disk in an example embodiment. The computer-readable medium of the memory, storage devices and the business integration application management system 132 with an integration application development platform 133 may store one or more sets of instructions 124, such as software code corresponding to the present disclosure.

The disk drive unit 114, static memory 106, and computer readable medium 122 of the integration application development platform user profiling module 126, the business integration application management system 132 with an integration application development platform 133, or the integration application development platform community collaboration system 128 also contain space for data storage such as an information handling system for managing locations of executions of customized integration processes in endpoint storage locations. Connector code sets, and trading partner code sets may also be stored in part in the disk drive unit 114, static memory 106, or computer readable medium 122 of the integration application development platform user profiling module 126 or the business integration application management system 132 with an integration application development platform 133 in an embodiment. In other embodiments, data profile code sets, and run-time engines may also be stored in part or in full in the disk drive unit 114, static memory 106, or computer readable medium 122 of the integration application development platform user profiling module 126 or the business integration application management system 132 with an integration application development platform 133. Further, the instructions 124 of the integration application development platform user profiling module 126, the business integration application management system 132 with an integration application development platform 133, or the integration application development platform community collaboration system 128 may embody one or more of the methods or logic as described herein.

In a particular embodiment, the instructions, parameters, and profiles 124, and the integration application development platform user profiling module 126, the business integration application management system 132 with an integration application development platform 133, or the integration application development platform community collaboration system 128 may reside completely, or at least partially, within the main memory 104, the static memory 106, disk drive 114, and/or within the processor 102 during execution by the information handling system 100. Software applications may be stored in static memory 106, disk drive 114, and the integration application development platform user profiling module 126, the business integration application management system 132 with an integration application development platform 133, or the integration application development platform community collaboration system 128.

Network interface device 118 may include a network interface controller (NIC) disposed within information handling system 100, on a main circuit board of the information handling system, integrated onto another component such as processor 102, in another suitable location, or a combination thereof. The network interface device 118 can include another information handling system, a data storage system, another network, a grid management system, another suitable resource, or a combination thereof.

The integration application development platform user profiling module 126, the business integration application management system 132 with an integration application development platform 133, or the integration application development platform community collaboration system 128 may also contain computer readable medium 122 as described. While the computer-readable medium 122 is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include the integration application development platform user profiling module 126, the business integration application management system 132 with an integration application development platform 133, or the integration application development platform community collaboration system 128. The integration application development platform user profiling module 126, the business integration application management system 132 with an integration application development platform 133, or the integration application development platform community collaboration system 128 may be operably connected to the bus 108. The integration application development platform user profiling module 126, the business integration application management system 132 with an integration application development platform 133, and the integration application development platform community collaboration system 128 are discussed in greater detail herein below.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, or module can include software, including firmware embedded at a device, such as an Intel® Core class processor, ARM® brand processors, Qualcomm® Snapdragon processors, or other processors and chipset, or other such device, or software capable of operating a relevant environment of the information handling system. The system, device or module can also include a combination of the foregoing examples of hardware or software. In an example embodiment, the integration application development platform user profiling module 126 and the business integration application management system 132 with an integration application development platform 133 above and the several modules described in the present disclosure may be embodied as hardware, software, firmware or some combination of the same. Note that an information handling system 100 can include an integrated circuit or a board-level product having portions thereof that can also be any combination of hardware and software. Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

In the embodiments described herein, the information handling system 100 may receive, at the network interface device 118, a plurality of integration application development platform operation logs recording metadata for tracking selections of integration process visual elements by a plurality of users for developing integration processes. The integration application development platform operation logs may be presented to the information handling system 100 using any format. In a specific embodiment, the integration application development platform operation logs may include XML data generated by any specific user as those users generate the integration process via the GUI 112 as described herein. However, the present specification does not limit the source of this metadata and contemplates that the metadata may be generated as a result of any interaction with the business integration application management system 132 with an integration application development platform 133 during the creation of a business integration process by any user.

In an embodiment, the business integration application management system 132 with an integration application development platform 133 may receive this metadata for further processing. In the embodiments described herein, the integration application development platform user profiling module 126, upon execution by the processor 102, creates a user profile associated with each of the plurality of users created using the metadata. In an embodiment, the metadata created by a specific user upon interaction with the GUI 112 is used to create the user profile for that user. The same may be repeated for each user who has, independently, created one or a plurality of integration process or who has interacted with the GUI 112 as described herein.

In some specific examples, the metadata used to develop the user's profile may be descriptive of any interaction of the user with the GUI 112 and business integration application management system 132 with an integration application development platform 133. In the embodiments described herein, this metadata may include metadata descriptive of each individual user's experience with the business integration application management system 132 with an integration application development platform 133, and specifically in some embodiments, an indication of which subset of visual element types were selected by the individual user. In an embodiment, the metadata may also be descriptive of each individual user's skill level in developing the business integration processes. In an embodiment, the metadata may also be descriptive of each individual user's experience in an industry the business integration processes are developed by the individual user to operate within. In yet another embodiment, the metadata may also be descriptive of the physical and geographical location of each of the users.

The metadata descriptive of the users' experience with the business integration application management system 132 with an integration application development platform 133, in some embodiments, may specifically include metadata indicating a subset of visual element types selected by the individual user, among a plurality of different visual element types, used to develop the business integration processes. As described herein, the GUI 112 in an embodiment may provide a visual designer environment permitting a user to define process flows between applications/systems, such as between trading partner and enterprise systems, and to model a customized business integration process through the manipulation of specific visual elements. The visual elements are representative of a code set that is to be executed by the processor 102 or other processing device in order to manipulate, store, read, write, and transmit data through the business integration processes. The arrangement and use of these different types of visual elements helps to create metadata that indicates each individual user's experience with the application development platform. The variety and number of these visual elements used in one or a plurality of business integration processes is also used to create metadata describing the expertise and experience of each of the users of the application development platform. After determining values for all of the above of any given user's experience level, this metadata may be used by the integration application development platform user profiling module 126 to determine a cumulative experience level for each user of the business integration application management system 132 with an integration application development platform 133.

As described, the metadata may also be descriptive of each individual user's skill level in developing the business integration processes. The metadata descriptive of any given user's skill level may include includes a number of business integration process steps used to develop the business integration process. As the visual elements are placed within the GUI 112 as described herein, the complexity of the business integration process may increase due to the interaction between the visual elements as well as the number of branches formed in the business integration process, the rate or frequency of the visual elements from the development of one business integration process to another, as well as the frequency any given user has used the business integration application management system 132 with an integration application development platform 133 (e.g., measured by login duration or frequency, for example) to create a business integration process. After determining values for all of the skill level indices of any given user's skill level, this metadata may be used by the integration application development platform user profiling module 126 to determine a cumulative skill level for each user of the business integration application management system 132 with an integration application development platform 133.

As described, the metadata may also be descriptive of each individual user's experience in an industry the business integration processes are developed by the individual user to operate within. This industry experience metadata may originate from an identification of keywords associated with any descriptions of any process visual elements or data manipulated at the visual elements used by the individual users to develop the business integration processes. By inspecting a combination of the names and descriptions used for the visual elements as well as any names and descriptions used for components of application solutions, field names in mappings, and the visual elements being connected to, the integration application development platform user profiling module 126 may conclude what industry the user is building the business integration process for. Such industries may include a finance industry, a human resources industry, a healthcare industry, and a manufacturing industry, among other types of industries.

As described herein, the metadata may also be descriptive of each individual users' physical location. In a specific embodiment, the metadata associated with the users' physical location may be obtained by accessing an internet protocol (IP) address of each user. In this embodiment, the users' may be accessing the business integration application management system 132 with an integration application development platform 133 via a browser at, for example, the information handling system 100 acting as a server system. Although specific embodiments described herein place the business integration application management system 132 with an integration application development platform 133, the integration application development platform user profiling module 126, and/or the integration application development platform community collaboration system 128 at a server-type information handling system 100, the present specification contemplates that any of these modules or systems may be remote to the information handling system 100 via, for example, a wired and/or wireless connection to this remote information handling system 100 over a network. In a specific embodiment, the information handling system 100 may include the business integration application management system 132 with an integration application development platform 133 and integration application development platform user profiling module 126 with the integration application development platform community collaboration system 128 being present on a server accessible by multiple information handling systems 100. Although specific embodiments described herein provide for specific configurations, the present specification contemplates that each of the business integration application management system 132 with an integration application development platform 133, integration application development platform user profiling module 126, and integration application development platform community collaboration system 128 may be located on any number of information handling systems 100 across a network 120 without going beyond the scope of the present specification.

After determining values for all of the users' skill levels, the users' experience level, the users' industry experience level, or the location of the users, the integration application development platform user profiling module 126 may create a profile of each user. These profiles are calculated and assigned to each of the users of the business integration application management system 132 with an integration application development platform 133 may be used to allow two or more users of the business integration application management system 132 with an integration application development platform 133 at the integration application development platform community collaboration system 128 to collaborate with each other. The integration application development platform community collaboration system 128 may provide the execution of a forum site or other communication system that the users may access to collaborate and, in specific embodiments, ask questions of and review answer from other users accessing the integration application development platform community collaboration system 128.

In the embodiments described herein, the user profiles associated with each of the users via execution of the integration application development platform user profiling module 126 may lead any given user to target a specific different user for answers to any questions they may have regarding the development a business integration processes. Because the users of the business integration application management system 132 with an integration application development platform 133 have had a user profile assigned to them, their expertise and skills associated with the use of any particular visual element or development of any particular business integration processes associated with a specific industry may be used to connect him or her to another user that may have questions regarding the same or similar visual elements or industry-specific business integration processes.

The integration application development platform community collaboration system 128 may connect two or more users together by first detecting a query or question from a first user. Again, this query may include a request for help or a question related to specific methods of creating a business integration processes, visual elements used, and industry specific business integration processes, among other questions related to the development of the business integration processes by the first user.

Once the query has been received from the first user, the integration application development platform community collaboration system 128 may then parse the natural language presented in the query from the first user in order to detect key words or phrases that allows the integration application development platform community collaboration system 128 to determine how and to whom the query could be directed. In an embodiment, the integration application development platform community collaboration system 128 may execute a text analytic process to compare those parsed key words in the query to other user profiles associated with any other user of the business integration application management system 132 with an integration application development platform 133. For example, the integration application development platform community collaboration system 128 may have parsed the query and detected text related to specific visual elements associated with specific applications such as QuickBooks, SalesForce' s® CRM Platform, Oracle's® Netsuite Enterprise Resource Planning (ERP) Platform, Infor's® WMS Application, Zuora's® SaaS business account applications, Amazon's® web services, Taleo's® Talent-Management Software, among others. These applications, as described herein, may be integrated via specific visual elements available to the first user to create the business integration processes at the GUI 112 of the business integration application management system 132 with an integration application development platform 133. Because these visual elements and associated applications may have been used in the development of a business integration processes by these other processes, the metadata associated with these other business integration processes will be reflected in each of the other users' profiles. This text in the query from the first user may be cross-referenced with any number of user profiles and the metadata developed and discovered by the integration application development platform user profiling module 126 in order to determine which of any other user has had any experience with similar applications and visual elements.

In a specific example embodiment, the text parsed within the query from the first user may indicate that an error message was generated when the user had attempted to develop, update, or test a business integration process. This error message may include certain text or even an error message code that other users had seen during their development, updating, or testing of their own business integration processes. In this specific example embodiment, the parsed error text or code may be used by the integration application development platform community collaboration system 128 to, alternatively or additionally, match other users' profiles to the error text or code in first user's query.

The parsing of text and matching of that text to specific users' profiles by the integration application development platform community collaboration system 128 may generate a preliminary list of matching users that the first user may be directed to in order to get help or insight into how to best implement the visual elements and applications used to develop the first user's business integration processes. The number of potential users presented on this preliminary list may be further reduced by the integration application development platform community collaboration system 128 by comparing each user profiles of the users presented on the preliminary list with the user profile associated with the first user. This additional level of matching the first user (e.g., the first user defined by his or her user profile) to any other user presented on the preliminary list may include comparing the metadata obtained by the integration application development platform user profiling module 126 to develop each user profile with the metadata associated with the first user's profile. In an embodiment, the integration application development platform community collaboration system 128 may additionally or alternatively confirm that any candidate user on the preliminary list also has experience in the application or visual elements the text of the query has indicated. In an embodiment, the integration application development platform community collaboration system 128 may determine which user profile associated with a user on the preliminary list indicates a matching industry the business integration processes were developed for on the first user's profile. In an embodiment, the integration application development platform community collaboration system 128 may additionally or alternatively determine which user profile associated with a user on the preliminary list indicates a matching time zone or geographical area as that of the profile of the first user.

In an embodiment, the integration application development platform community collaboration system 128 may additionally or alternatively determine which user profile associated with a user on the preliminary list indicates a greater or, at least, the best user skill level regarding the users' use of visual elements or applications in a business integration process as compared to the first user's profile. In an embodiment, the integration application development platform community collaboration system 128 may additionally or alternatively determine which user profile associated with a user on the preliminary list indicates an equivalent or better skill match as that of the first user. In this embodiment, the integration application development platform community collaboration system 128 may review any given user's profile to determine an average or mean number of visual elements used per business integration process, an average or mean number of visual different visual elements used across a plurality of business integration processes, and/or an average or mean of the number of steps used to develop the business integration process.

Once the preliminary list has been reduced via these matching processes conducted by the integration application development platform community collaboration system 128, a final list of users who may be able to answer the first user's question may be created. This final list may be maintained by the integration application development platform community collaboration system 128 on behalf of the first user.

In an embodiment, the integration application development platform community collaboration system 128 may provide a notice to any one of the other users on the final list of users that the first user has posted a query. In an embodiment, the integration application development platform community collaboration system 128 may send communication, such as a message via the GUI 112, an internet message, an email, or other electronic communication, to any or all of the other users on the final list requesting that they each view and/or address the first user's query. Because each of the users on the final list can help to address the first user's query, any of these other users may be qualified to answer the query. In an embodiment, the integration application development platform community collaboration system 128 may rank the other users presented on the final list from most relevant to least relevant.

By connecting each of the users of the business integration application management system 132 with an integration application development platform 133 at an integration application development platform community collaboration system 128 a community of users may collaborate to develop better, streamlined business integration processes. With over an estimated 25 million computer programmers world-wide, the integration application development platform community collaboration system 128 may bring any users together that have similar experiences with regard to using specific visual elements in a specific industry. The skills of one user may be used to help increase the skills of other users thereby increasing the abilities of the programming community on the integration application development platform community collaboration system 128.

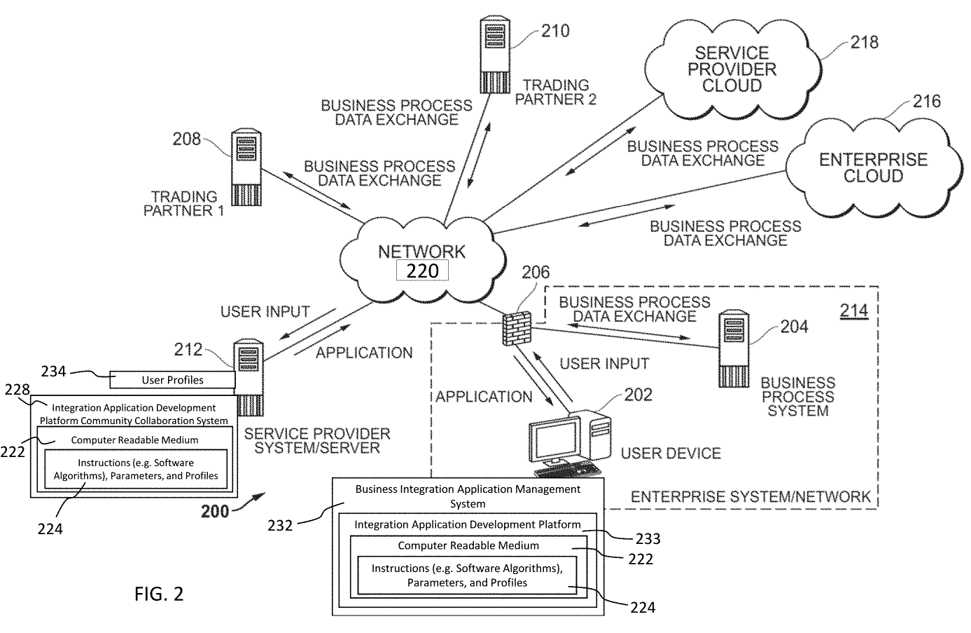

FIG. 2 is a graphical diagram illustrating a simplified integration network 200 including a service provider system/server 212 and an enterprise system/network 214 in an embodiment according to the present disclosure. Actual integration network topology could be more complex in some other embodiments. As shown in FIG. 2, an embodiment may include computing hardware of a type that may be found in client/server computing environments. More specifically, the integration network 200 in an embodiment may include a user/client device 202, such as a desktop or laptop PC, enabling a user to communicate via the network 220, such as the Internet. In another aspect of an embodiment, the user device 202 may include a portable computing device, such as a computing tablet, or a smart phone. The user device 202 in an embodiment may be configured with a web browser software, such as Google Chrome®, Firefox®, or Microsoft Corporation's Internet Explorer® for interacting with websites via the network 220. In an embodiment, the user device 202 may be positioned within an enterprise network 214 behind the enterprise network's firewall 206. As a further aspect of an embodiment, the enterprise network 214 may include a business process system 204, which may include computer hardware and business integration application management system with an integration application development platform such as QuickBooks, SalesForce's® CRM Platform, Oracle's® Netsuite Enterprise Resource Planning (ERP) Platform, Infor's® WMS Application, Zuora's® SaaS business account applications, Amazon's® web services, Taleo's® Talent-Management Software, or many other types of databases.

In an embodiment, the integration network 200 may further include trading partners 208 and 210 operating hardware and software used for receiving and/or transmitting data relating to business-to-business transactions. For example, Walmart® may operate trading partner system 208 to allow for issuance of purchase orders to suppliers, such as the enterprise 214, and to receive invoices from suppliers, such as the enterprise 214, in electronic data form as part of electronic data exchange processes. Electronic data exchange process in an embodiment may include data exchange via the world wide web. In other embodiments, electronic data exchange processes may include data exchange via FTP or SFTP.

In an embodiment, a provider of a service (“service provider”) for creating on-demand, real-time creation of customized data integration software applications may operate a service provider server/system 212 within the integration network 200. The service provider system/server 212 may be specially configured in an embodiment, and may be capable of communicating with devices in the enterprise network 214. The service provider system/server 212 in an embodiment may host a business integration application management system 232 with an integration application development platform 233 in an embodiment similar to the business integration application management system 132 with an integration application development platform 133 described above in connection with FIG. 1. Such a business integration application management system 232 with an integration application development platform 233 may allow a user of the business integration application management system 232 with an integration application development platform 233 to model a business integration processes including one or more sub-processes for data integration through a business process data exchange between an enterprise system/network 214 and outside entities or between multiple applications operating at the business process system 204. The integration process modeled in the integration process-modeling graphical user interface in an embodiment may be a single business process data exchange shown in FIG. 2, or may include several business process data exchanges shown in FIG. 2. For example, the enterprise system/network 214 may be involved in a business process data exchange via network 220 with a trading partner 1, and/or a trading partner 2. In other example embodiments, the enterprise system/network 214 may be involved in a business process data exchange via network 220 with a service provider located in the cloud 218, and/or an enterprise cloud location 216. For example, one or more applications between which a data model field value may be transferred, according to embodiments described herein, may be located remotely from the enterprise system 214, at a service provider cloud location 218, or an enterprise cloud location 216.

The user of a business integration application management system 232 with an integration application development platform 233 in an embodiment may model one or more business integration processes via network 220 within an integration process by adding one or more visual elements or code sets to an integration process flow. These visual elements in an embodiment may model the ways in which a user wishes data to be accessed, moved, and/or manipulated during the one or more business integration processes that facilitate, for example, business process data exchanges. Each visual element (also referred to as a connector element or a shape) the data integration protection assistance system or the user adds to the integration process flow diagram in an embodiment may be associated with a pre-defined subset of code instructions stored at the service provider systems/server 212 in an embodiment. Upon the user modeling the business integration processes, the service provider system/server 212 in an embodiment may generate a run-time engine capable of executing the pre-defined subsets of code instructions represented by the visual elements chosen by the user or indicated by the business integration processes developed at the business integration application management system 232 with an integration application development platform 233. The runtime engine may then execute the subsets of code instructions in the order defined by the modeled flow of the visual elements given in the integration process flow diagram. In some embodiments, the data integration protection assistance system may define the order in which such subsets of code instructions are executed by the runtime engine without creation of or reference to a visual integration process flow diagram. In such a way, a business integration process may be executed without the user having to access, read, or write the code instructions of such a business integration process.

In other aspects of an embodiment, a user may initiate a business process data exchange between one cloud service provider 218 and one cloud enterprise 216, between multiple cloud service providers 218 with which the enterprise system 214 has an account, or between multiple cloud enterprise accounts 216. For example, enterprise system 214 may have an account with multiple cloud-based service providers 218, including a cloud-based SalesForce® CRM account and a cloud-based Oracle® Netsuite account. In such an embodiment, the enterprise system 214 may initiate business process data exchanges between itself, the SalesForce® CRM service provider and the Oracle® Netsuite service provider.

During operation of the service provider system/server 212 and/or the business integration processes, a user may collaborate with other users when developing a business integration processes. For example, as described herein, the user device 202 may include the business integration application management system 232 with an integration application development platform 233 used by a first user to develop a business integration process. The business integration application management system 232 with an integration application development platform 233 may present a GUI to the first user to allow the user to create a new business integration processes by, for example, dragging and dropping a number of visual elements and connecting them into a flow diagram. Occasionally, this first user may require insight or help when developing the business integration processes due to a lack of experience with a particular visual element, a lack of experience with visual elements related to a particular industry, a lack of skills in interfacing a number of visual elements together, or other inexperience related to the development of a business integration process. The first user may, in the embodiments described herein, send a query related to their development of the business integration process to an integration application development platform community collaboration system 228. The integration application development platform community collaboration system 228 then connects the first user to another user of the business integration application management system 232 with an integration application development platform 233 232 as described herein in connection with FIG. 1. Because the service provider systems/server 212 maintains a database of user profiles 234 developed by an integration application development platform user profiling module as described herein, the integration application development platform community collaboration system 228 may connect the first use to another user that is most experienced with the types of visual elements being used by the first user and who is most experienced with the industry the business integration processes is being built for. For example, the first user may be attempting to develop a business integration process related to a healthcare insurance billing business integration process. The integration application development platform community collaboration system 228 may retrieve the first user's profile and match that first user with another user whose profile indicates that he or she can address the first user's query.

In a specific example, the integration application development platform community collaboration system 228 may receive the query and parse the text of the query and, via execution of a text analytic process, determine which visual elements, error codes, and industries the business integration process being developed by the first user is related to. Because each user profile is created using metadata descriptive of how many and what kind of business integration processes have been developed by each of those users, the integration application development platform community collaboration system 228 may be able to determine which, among the plurality of other users, has actually had experience with similar business integration processes. This preliminary list of users may be further reduced by determining which of the other user's profile best matches the first user's profile. Specific development of these user profiles 234 is described herein. The user profiles 234 may be created using, for example, the integration application development platform user profiling module described in connection with FIG. 1 and elsewhere herein.

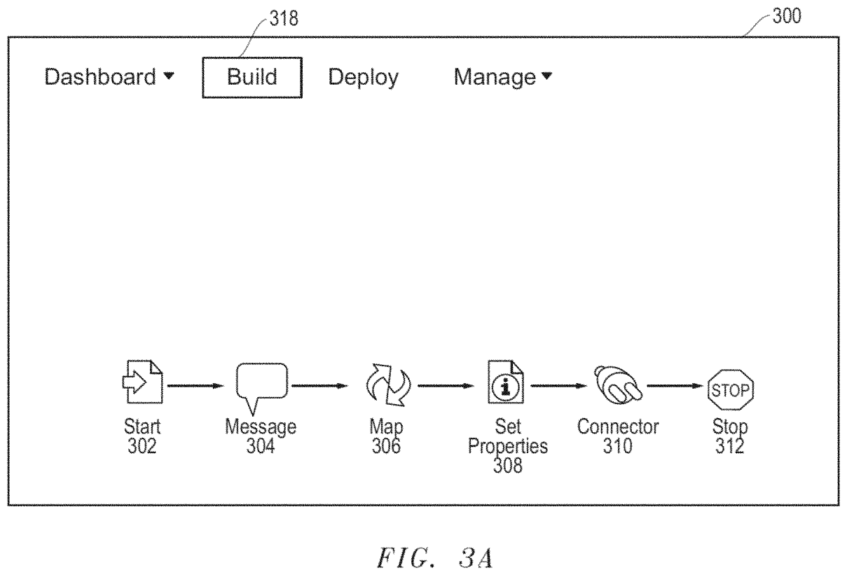

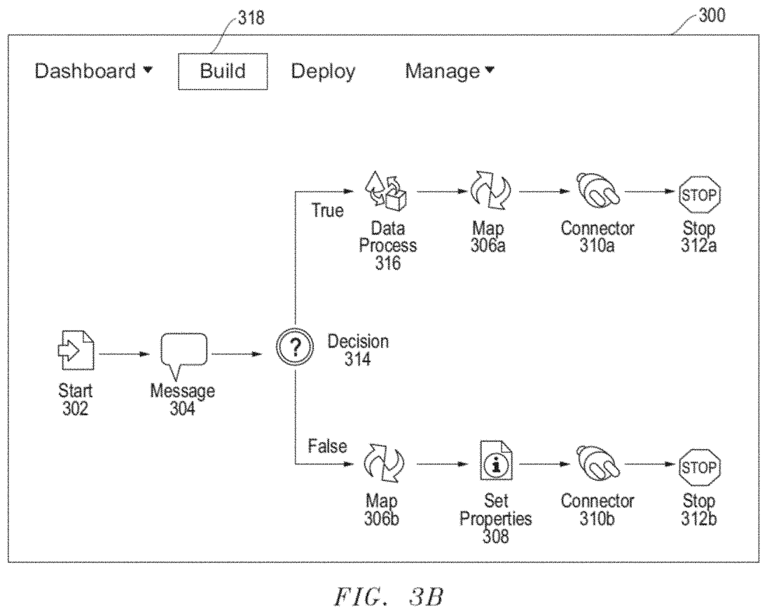

FIG. 3A is a graphical diagram illustrating a user-generated flow diagram of a business integration process for exchange of electronic data records according to an embodiment of the present disclosure. As described herein, the integration application user profiles are developed using any given users use of the business integration application management system with an integration application development platform including the use of specific visual elements, visual elements associated with specific industries, and the complexity of the use of the visual elements. The flow diagram illustrated in the example graphical user interface 300 shows that a number of visual elements 302, 304, 306, 308, 310, 312 have been deployed and connected in order to develop the business integration process. Each of the visual elements are associated with specific computer executable code that, when executed, performs a function associated with the business integration process. As described herein, the type of visual elements used, the complexity of the business integration process developed, and the industry the visual elements and/or business integration process is associated with is used to develop a user profile of each user of the business integration application management system with an integration application development platform as described herein. It is appreciated, therefore, that as any given user of the business integration application management system with an integration application development platform interacts with the graphical user interface 300 and the business integration application management system with an integration application development platform to develop the business integration process further defines that user's profile based on the metadata that is gathered from such use.

The flow diagram in an embodiment may be displayed within a portion of a graphical user interface 300 that allows the user to build the process flow, deploy the business integration process modeled thereby, manage data model field values manipulated by such an business integration process, and to view high-level metrics associated with execution of such an integration process. In an embodiment, the user may build the process flow and view previously built process flow diagrams by selecting the “Build” tab 318 in an embodiment. A user may generate a flow diagram in an embodiment by providing a chronology of process-representing integration elements (aka visual elements) via the use of an integration process-modeling user interface. In some embodiments, the integration process-modeling user interface may take the form of a visual user interface. In such embodiments, the user-selectable elements representing integration sub-processes (e.g. visual elements) may be visual icons. In an embodiment, the visual icons or visual elements may be particular to any application or process incorporated into the business integration processes and may be visually representative of, for example, the applications such as QuickBooks, SalesForce's® CRM Platform, Oracle's® Netsuite Enterprise Resource Planning (ERP) Platform, Infor's® WMS Application, Zuora's® SaaS business account applications, Amazon's® web services, Taleo's® Talent-Management Software, among others. Other visual elements may be generic connectors that indicate, for example, that messages are being sent (e.g., message 304).

An integration process-modeling user interface in an embodiment may provide a design environment permitting a user to define process flows between applications/systems, such as between trading partner and enterprise systems, between on-site data centers and cloud-based storage modules, or between multiple applications, and to model a customized business integration process. Such a business integration process-modeling user interface in an embodiment may provide a menu of pre-defined user-selectable elements representing integration sub-processes and permit the user to arrange them as appropriate to model a full integration process. For example, in an embodiment in which the integration process-modeling user interface is a visual user interface, the elements may include visual, drag-and-drop icons representing specific units of work (known as process components or visual elements) required as part of the business integration process. Such visual elements in an embodiment may include invoking an application-specific connector to access, and/or manipulate data. In other embodiments, visual elements may include tasks relating to transforming data from one format to another, routing data down multiple paths of execution by examining the contents of the data, business logic validation of the data being processed, etc.

Each visual element as represented by integration sub-process icons or elements may be identifiable by a visual element type, and may further include an action to be taken. For example, a visual element may be identified as a “connector” component or a “shape.” Each “connector” component, when chosen and added to the process flow in the integration process-modeling graphical user interface of a integration application development platform, may allow the user to choose from different actions the “connector” component may be capable of taking on the data as it enters that process step. Further the integration-process modeling graphical user interface in an embodiment may allow the user to choose the data set or data element upon which the action will be taken. The action and data element the user chooses may be associated with a connector code set, via the business integration application management system, which may be pre-defined and stored at a system provider's memory in an embodiment. The business integration application management system operating at least partially at a system provider server/system in an embodiment may generate a dynamic runtime engine for executing these pre-defined subsets of code instructions correlated to each individual process-representing visual element a given flow diagram in the order in which they are modeled in the given flow diagram, or by the data integration protection assistance system in a non-visual format.

In an embodiment, a user may choose a visual element it uses often when interfacing with a specific trade partner or application, and define the parameters of that visual element by providing parameter values specific to that trading partner or application. If the user wishes to use this visual element, tailored for use with that specific trading partner or application repeatedly, the user may save that tailored visual element as a trading partner or component named specifically for that application. For example, if the user often accesses NetSuite® or SalesForce®, the user may create a database connector visual element, associated with a pre-built connector code set that may be used with any database, then tailor the database connector visual element to specifically access NetSuite® or SalesForce® by adding visual element parameters associated with one of these applications. If the user uses this visual element in several different integration processes, the user may wish to save this visual element for later use by saving it as a NetSuite® or SalesForce® visual element. In the future, if the user wishes to use this component, the user may simply select the NetSuite® or SalesForce® component, rather than repeating the process of tailoring a generic database connector visual element with the specific parameters defined above. The frequency of use, levels of complexity, or types of connectors used as well as types of applications and data descriptive identifiers used with such visual connectors may be recorded and stored with received integration application development platform operation logs as users develop business integration processes with the integration application development platform such as via GUI 300. This integration application development platform operation log information may be used by the integration application development platform user profiling module as inputs for a machine learning or other classifier to generate or populate an integration application user profile in example embodiments herein.

As shown in FIG. 3A, such process-representing visual elements may include a start element 302, a message element 304, a map element 306, a set properties element 308, a connector element 310, and a stop element 312. Other embodiments may also include a branch element, a decision element, a data process element, or a process call element, for example. A connector element 310, and a start element 302 in an embodiment may represent a sub-process of a business integration process describing the accessing and/or manipulation of data. The start element 302 in an embodiment may also operate as a connector element.

In an embodiment, a start element 302 may operate to begin a process flow, and a stop element 312 may operate to end a process flow. As discussed herein, each visual element may require user input in order for a particular enterprise or trading partner to use the resulting process. The start element 302 in an embodiment may further allow or require the user to provide data attributes unique to the user's specific integration process, such as, for example, the source of incoming data to be integrated. For example, the user or the data integration protection assistance system may use a connector element to define a connection (e.g., an application managing data upon which action is to be taken), and the action to be taken. A user may use a connector element to further define a location of such data, according to the language and storage structure understood by the application managing such data. In addition, the data to be accessed according to such a start element 302 may be identified by a data model fieldname given in a format that adheres to the code language and storage structure used by the application/location/enterprise at which such a data model field value may be accessed.

A map element 306, or TransformMap element in an embodiment, may associate a first data model fieldname for a data model field value being retrieved from a first application or source with a second data model fieldname under which that data model field value will be stored at a second application or destination. A user may also provide an operation name that describes the purpose for changing the data model fieldnames of the data model field value in such a way. Because a single integration process may transmit data model field values between or among several sources and destinations, a process flow may include several of these mapping elements 306, sometimes placed in series with one another. This may result in a single data model field value receiving several different data model fieldnames as it moves from various sources to various destinations throughout the integration process. As described herein, the data model fields and their associated values may be used by an integration application development platform user profiling module to develop any profile for any user of the business integration application management system with an integration application development platform and graphical user interface 300. In a specific embodiment, the data model fields may generate metadata indicative of an industry in which the business integration process was built for. This metadata is used to develop an integration application user profile as well as to match a first user presenting a query at an integration application development platform community collaboration system with another user with experience in that industry.

A set properties element 308 in an embodiment may allow the user to set values identifying specific files. Set properties elements in an embodiment may associate a user-defined property with a user-defined parameter, similar to a key-value pair definition. In an example embodiment, a user of the data integration protection assistance system of the business integration application management system with an integration application development platform may use a set properties element to set the property “data model fieldname” to a parameter “Shipping Address,” in order to identify a specific data model field value entitled “Shipping Address.” In some embodiments, this may invoke a call to an API controlling access to the application/location/enterprise managing such a data model field value to search for a data model field value having a data model fieldname that matches one or more of these descriptive phrases, rather than identifying a data model field value having the exact data model fieldname “Shipping Address.” For example, a user entering the value “Shipping Address” in an embodiment may invoke a call to locate data model field values having data model fieldnames “Shipping_Address,” “shipping_address,” “ShippingAddress,” “SAddress,” etc. This metadata may also be used as inputs to an integration application development platform user profiling module to develop an integration application user profile as well as to match a first user presenting a query at an integration application development platform community collaboration system with another user with experience in that industry.

The code sets associated with such property and parameter fields in an embodiment may be written in any programming code language, so long as the code language in which the property is defined matches the code language in which the parameter is also defined. Similarly, the code sets associated with the connection location and action to be taken within a connector element may be written in any programming code language so long as they are consistent with one another. Thus, the process-representing elements in an embodiment may be programming language-agnostic. Using such process-representing elements in an embodiment, a user may model an end-to-end integration process between multiple applications that each use different naming conventions and storage structures for storage of data model field values. As a result, a single data model field value accessed at the start element 302 and transmitted to a second location at the connector element 310 in an embodiment may be identified at the start element 302 with a completely different data model fieldname (e.g., “Social_Security_Number”) than the data model fieldname (e.g., “Title”) used to identify the exact same data model field value at the connector element 310. During operation of an integration application development platform user profiling module, the use of specific code sets may also be used as metadata to develop a user profile as described herein.

If a user anticipates a modeled integration process may access, copy, transmit, or otherwise manipulate a data model field value likely to include sensitive information (e.g., personal information protected under the GDPR), the user may provide terms describing such data within a message element 304 in an embodiment. For example, a user may add a message element 304 to the visual flow process within the user interface, which may then prompt the user to provide one or more search terms that a data integration protection assistance system may use to identify or track potentially sensitive information, as described in greater detail herein. This data integration protection assistance system in embodiments described herein may operate to identify, label, and track the ways in which such given data model field value information is handled throughout the integration process modeled by the user, despite the plurality of data model fieldnames used to identify such information throughout the process. Accordingly, this metadata as well may be used as inputs to an integration application development platform user profiling module to develop an integration application user profile as well as to match a first user presenting a query at an integration application development platform community collaboration system with another user with experience in that industry.

FIG. 3B is a graphical diagram illustrating a user-generated flow diagram of a business integration process via a business integration application management system with an integration application development platform providing added security for exchange of electronic data records containing personal information according to an embodiment of the present disclosure. The added security in the flow diagram may be in response to the general data protection regulation (GDPR) of European law. The GDPR contains several provisions requiring controllers of personal data (e.g., enterprises engaged in data integration processes) to place an appropriate technical and organization measures to implement data protection principles. The business integration application management system with an integration application development platform in an embodiment may operate to identify sensitive information and apply added security measures to integration processes involving such sensitive information, to avoid the risk of infringing the GDPR.

In embodiments described herein, an business integration application management system with an integration application development platform along with any security protocols (e.g., a data integration protection assistance system) may search code instructions for one or more integration processes to identify data model field values accessed, copied, transferred, or otherwise manipulated therein that may contain sensitive information. Upon identification of a data model field value meeting preset search terms provided by the user within the message element 304 and designed to identify sensitive information, the data integration protection assistance system in embodiments may label the identified data model field value as sensitive using one or more of a plurality of labels. The data integration protection assistance system in an embodiment may then apply greater security measures to data model field values identified in such a way as sensitive.

For example, the data integration protection assistance system in an embodiment may automatically adjust the integration process modeled by the user via the user interface, as described with reference to FIG. 3A, by adding an encryption layer to all data model field values identified as potentially sensitive. As described herein, a user may view and edit previously built process flow diagrams by selecting the “Build” tab 318 within the graphical user interface 300 in an embodiment. As shown in FIG. 3B, the data integration protection assistance system may insert a decision element 314 immediately following the message element 304. The decision element 314 in such an embodiment may route incoming data model field values based on whether they meet a preset criterion. For example, the data integration protection assistance system in an embodiment may associate the decision element 314 with a statement, such as, “the incoming data model field value meets one or more of the search criteria provided by the user within the message element 304.” If such an assigned statement proves true (e.g., the incoming data model field value meets the search terms for sensitive information), this may indicate the incoming data model field value may contain personal identification information, and the decision element 314 may route the integration process including that data model field value toward data process element 316, which may operate to apply added security, such as an encryption algorithm to the integration process. If such an assigned statement proves false, this may indicate the incoming data model field value likely does not contain personal identification information, and the decision element 314 may route the integration process toward the map element 306b.

It is noted that the user-generated flow diagram of a business integration process shown in FIG. 3B is relatively more complex than that shown in FIG. 3A. As described herein, the relative complexity of the user-generated flow diagram of a business integration process in FIG. 3B may be used as metadata to be incorporated by the integration application development platform user profiling module when developing a user's profile. In the embodiment shown in FIG. 3B, the user-generated flow diagram of a business integration process is shown to branch at a decision point. This is a feature not presented in the user-generated flow diagram of a business integration process of FIG. 3A. As such, a developer of the user-generated flow diagram of a business integration process in FIG. 3B would be reflected in the metadata used to create that user's profile and may place that user higher on either of the preliminary lists or final lists by the integration application development platform community collaboration system in order to match a first user with this user when the first user has presented a query at the integration application development platform community collaboration system. The complexity of the user-generated flow diagram of a business integration process may also be indicative of the user's skill level in both the use of visual elements as well as the complexity of those used visual elements relative to each other. It is also understood that because the user-generated flow diagram shown in FIG. 3B, as opposed to FIG. 3A, includes multiple instances of similar or same visual elements, that a rate or frequency of usage of the visual elements may indicate a relatively higher experience level with these visual elements.

As described herein, each of the user-generated flow diagrams of a business integration process shown in FIG. 3A and FIG. 3B may be used by the integration application development platform user profiling module to develop a profile of the user who developed them. For convenience of explanation, the user-generated flow diagram of a business integration processes of FIGS. 3A and 3B were developed by the same user of the business integration application management system with an integration application development platform. During operation of the business integration application management system with an integration application development platform, the integration application development platform user profiling module may glean metadata from the user's interactions with the graphical user interface 300. This metadata may be descriptive of which applications the business integration processes the user creates and what each visual element connects to; the composition of the data mappings created and used with the visual elements used; the constructs are used in the business integration processes created and modified for this user; how the degrees of complexity varies of the use of constructs; the rate/frequency of usage of the application development platform; the combination of the names and descriptions used for the business integration processes; the names and descriptions used for the visual elements of the business integration processes; the field names associated with the mappings and the visual elements being connected to. Further the metadata of identified data model field values accessed, copied, transferred, or otherwise manipulated within a business integration process or any labels of the identified data model field value such as those identifying sensitive information using one or more of a plurality of labels may indicate industry types for business integration processes, types or number of connectors used, or complexity of business integration processes. All of this metadata may be accumulated and used by the integration application development platform user profiling module via a machine learning algorithm or other supervised learning algorithm to develop and populate fields for the integration application user profile for this user. The profiles may then be used by the integration application development platform community collaboration system to match this first user with another user who could address a query presented by the first user.

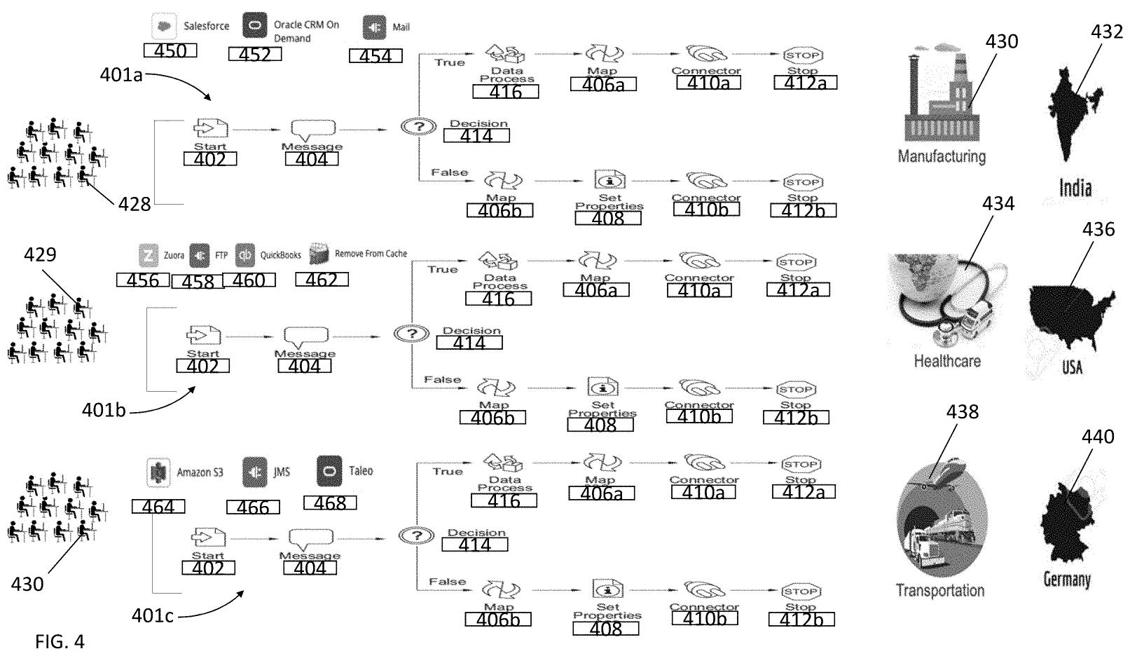

FIG. 4 is a graphical diagram illustrating a plurality of user-generated flow diagrams 400 produced for a plurality of users 428a, 428b, and 428c according to an embodiment of the present disclosure. Each user within the groups 428a, 428b, and 428c may develop one or more unique user-generated flow diagrams 400a, 400b, and 400c via the business integration application management system with an integration application development platform described in various embodiments herein. Again, each of the flow diagrams show for illustrative purposes that a number of visual elements 402, 404, 406a, 406b, 408, 410a, 410b, 412a, 412b, 414, 416 have been deployed and connected in order to develop the business integration process. Although each of the individual user-generated flow diagrams 400 look similar, the present specification contemplates that other user-generated flow diagrams 400a, 400b, and 400c will be a plurality of user-generated flow diagrams that are unique to each user within the groups of users 428a, 428b, and 428c and may have varying degrees of variety. The user-generated flow diagrams 400a, 400b, and 400c shown in FIG. 4 are not specifically illustrative of any particular user-generated flow diagrams 400a, 400b, and 400c associated with groups 428a, 428b, or 428c and are only shown for purposes of brevity that unique user-generated flow diagrams 400a, 400b, and 400c are generated by users of groups 428a, 428b, and 428c. Thus, for a group of users 428a, user-generated flow diagram 400a is only an illustrative example of one of many unique user-generated flow diagrams for business integration process flows that may be developed by the first group of users 428a. Similarly, for the group of users 428b, user-generated flow diagram 400b is only an illustrative example of one of many unique user-generated flow diagrams for business integration process flows that may be developed by the second group of users 428b. Additionally, for the group of users 428c, user-generated flow diagram 400c is only an illustrative example of one of many unique user-generated flow diagrams for business integration process flows that may be developed by the third group of users 428c.

As can be seen, metadata of types of connectors used, applications types, or actions involved with visual elements for the user-generated flow diagrams 400a, 400b, and 400c such as 450, 452, 454, 456, 458, 460, 462, 464, 466 and 468, and in some aspects locations 432, 436, or 440 may be used by the integration application development platform user profiling module described herein to determine integration application user profiles for each user within groups 428a, 428b, and 428c. Those integration application user profiles may contain similar indicators such as similar industry types associated with each user within a group 428a, 428b, and 428c. For example, users in group 428a may have indicators that may be associated by the integration application development platform user profiling module with a manufacturing industry sector 430 in an embodiment. Users in group 428b may have indicators that may be associated by the integration application development platform user profiling module with a healthcare industry sector 434 in another embodiment. Users in group 428c may have indicators that may be associated by the integration application development platform user profiling module with a transportation industry sector 438 in yet another embodiment.

FIG. 4 is intended to illustrate that each of the users within groups 428a, 428b, and 428c using the business integration application management system with an integration application development platform is developing unique business integration processes. Each of these business integration processes may, in an embodiment, be represented by any number of XML files that are stored on a memory accessible to the integration application development platform user profiling module. These XML files may be stored in a cloud server system in some embodiments for access by a remote integration application development platform user profiling module. Metadata for types of applications accessed or targeted and operated upon by the visual elements or connectors of the unique business integration processes as well as metadata indicating types of data or labels of data being manipulated or transformed may indicate industry types such as 430, 434, or 438. Such metadata and indications input into a machine learning classifier or other supervised learning algorithm of the integration application development platform user profiling module may be used to generate user profiles for users indicating industry types in embodiments herein.

As each of the business integration processes represented by the user-generated flow diagrams 400a, 400b, 400c are generated, the metadata associated with their creation may be associated with the user who created it in order to develop the integration application profile of the user as described herein. FIG. 4 shows the ability of the integration application development platform user profiling module to group any number of users 428a, 428b, and 428c based on, for example, the industry 430, 434, 438 the business integration process was developed for. Example industries include a manufacturing industry 430, a healthcare industry 434, and a transportation industry 438. As described herein, data model fields associated with each visual element may generate metadata indicative of the industry in which the business integration process was built to operate within. For example, the data model fields may be created or modified by a user within group 428b indicating a fieldname “patient ID.” When detected, the integration application development platform user profiling module may determine that such a fieldname is indicative of the fact that the visual element used is part of a business integration process associated with the healthcare industry 434. As such, this user's profile will indicate that the user is developing or has developed business integration processes exemplified by the illustrated user-generated flow diagram 400b associated with the healthcare industry 434. This indicates to the integration application development platform community collaboration system that this user has experience in this industry and should be matched with another user when that other user presents a query in the integration application development platform community collaboration system.

FIG. 4 also shows a geographical location 432, 436, 440 of any number of users within groups 428a, 428b, and 428c operating the business integration application management system with an integration application development platform. Again, this metadata may be obtained by the integration application development platform user profiling module from, for example, an IP address used to access the business integration application management system with an integration application development platform or integration application development platform community collaboration system. Other methods may be used to determine the physical, geographical location of each user in groups 428a, 428b, and 428c and the present specification contemplates the use of these other methods. The metadata associated with the geographic location of the users of groups 428a, 428b, and 428c may be used by the integration application development platform user profiling module to define, for example, a perceived language of the users within each group 428a, 428b, and 428c as a part of an integration application user profile. Location 432, 436, 440 may be a different grouping criteria within integration application user profiles of user groups 428a, 428b, and 428c and may be independent of industry type groupings shown as 430, 434, and 438. In other embodiments, combinations of grouping criteria may define or describe each group of users 428a, 428b, and 428c.

Although not dispositive of the language a user may speak, this metadata may be used by the integration application development platform community collaboration system to better match users who speak or could speak the same language based on integration application user profiled generated with an integration application development platform user profiling module. Although FIG. 4 shows India 432, the USA 436, and Germany 440 as location where the users 428a, 428b, and 428c may be present, the present specification contemplates that the geolocation could be anywhere in the world and, accordingly, reflected in the user's profiles within groups 428a, 428b, and 428c. Additionally, the metadata describing the geolocation of the users may be provide with any level of granularity such as street blocks, cities, counties, states, countries, and continental locations and the present specification contemplates these varying degrees of granularity.

Again, the user-generated flow diagrams 400a, 400b, and 400c shown in FIG. 4 may be used as a specific source of metadata used by the integration application development platform user profiling module to develop the integration application user profiles of the users within groups 428a, 428b, and 428c that created the user-generated flow diagrams shown as examples at 400a, 400b, and 400c. This metadata source from unique user-generated flow diagrams such as examples at 400a, 400b, and 400c may include metadata descriptive of the user's 428 application skills. For example, the metadata from the unique user-generated flow diagrams may have indicators of application types handled within the uniquely modeled business integration process flows by the visual elements or connectors such as within examples at 400a, 400b, and 400c.

The metadata may indicate that one or more application types is utilized within the visual elements or connectors of the uniquely modeled business integration process flows illustrated as examples 400a, 400b, and 400c for each group of users 428a, 428b, and 428c. In an example embodiment, users in group 428a may be shown to have experience with applications such as Salesforce® 450, Oracle® CRM 452, or one or more mail application types 454. Experience with these application types discerned from metadata may be included in integration application user profiles of users within group 428a in some embodiments. In further examples, such application types 450, 452, or 454 may be indicative of an industry type for a group 428a in some embodiments, such as manufacturing industry sector 430.

In another example embodiment, users in group 428b may be shown to have experience with applications such as Zuora® 456, Quickbooks® 460, or one or more file transfer protocol (FTP) type application connectors 458. Further, users in group 428b may have experience with connectors types designed to perform specific actions such as removing data from caches 462. Experience with these application types discerned from metadata may be included in integration application user profiles of users within group 428b in some embodiments. In some embodiments, such application types 456, 460, connection types 462, or actions by connectors 462 such as removing potentially sensitive healthcare data from cache may be indicative of an industry type for a group 428b in some embodiments, such as the healthcare industry sector 434.

In yet another example embodiment, users in group 428c may be shown to have experience with applications such as Amazon® S3 464, Taleo® 468, or one or more Java Message Service (JMS) type application connectors 466. Experience with these application types discerned from metadata may be included in integration application user profiles of users within group 428c in some embodiments. In some embodiments, such application types 464, 468, or connector types 466 may be indicative of an industry type for a group 428c in some embodiments, such as the transportation industry sector 438.

In another embodiment, other metadata may include metadata descriptive of the user's application skills. A user may be using only a subset of the capabilities provided to them via the types of visual elements. For example, a user with group 428a may be only using these following visual elements in their solutions: Salesforce® Connector 450, Oracle® CRM Connector 452, and a Mail Connector 454. This allows the integration application development platform user profiling module to input such metadata to a machine learning classifier to determine that the user in group 428a has skills in creating integration solutions that use those specific visual elements but not necessarily other types of visual elements. Additionally, the complexity of the arrangement of the visual elements or the complexity of the visual elements themselves may also be used by the integration application development platform user profiling module to determine the user's expertise in business integration process development.

Additionally, the metadata may include metadata descriptive of the user's skill levels generally, in an embodiment. A skill level rating for a user may be based on one, a plurality, or all of the business integration processes developed by that user. The integration application development platform user profiling module may determine, for example, how many visual elements are used in each of the business integration processes. If a mean or average use of any specific visual element meets or exceeds a predetermined value, the integration application development platform user profiling module may determine that the user is skilled at using that visual element. In a specific embodiment, this threshold value is 3 uses for example. In an embodiment, the skill level rating for the user may also or alternatively be based on the different types of visual elements within the business integration processes the integration application development platform user profiling module detects. If a mean or average use of different types of visual element meets or exceeds a predetermined value, the integration application development platform user profiling module may deduce that the user is skilled at using visual elements within a level of business integration process complexity. In a specific embodiment, this threshold value is 10 variations for example. In an embodiment, the skill level rating for the user may also or alternatively be based on the number of steps used within the business integration process and detected by the integration application development platform user profiling module. The number of steps within the business integration process may be counted by counting the number of process lines present between any visual element represented in the user-generated flow diagrams. In the examples shown in the illustrative example user-generated flow diagrams 400a, 400b, or 400c of FIG. 4, the number of steps is 10. This number will be unique for each unique user-generated flow diagrams of users in groups 428a, 428b, or 428c. If a mean or average number of steps meets or exceeds a predetermined value, the integration application development platform user profiling module may deduce that the user is at a particular qualitative skill level. In a specific embodiment, this threshold value may be 8 steps to meet an intermediate skill level.

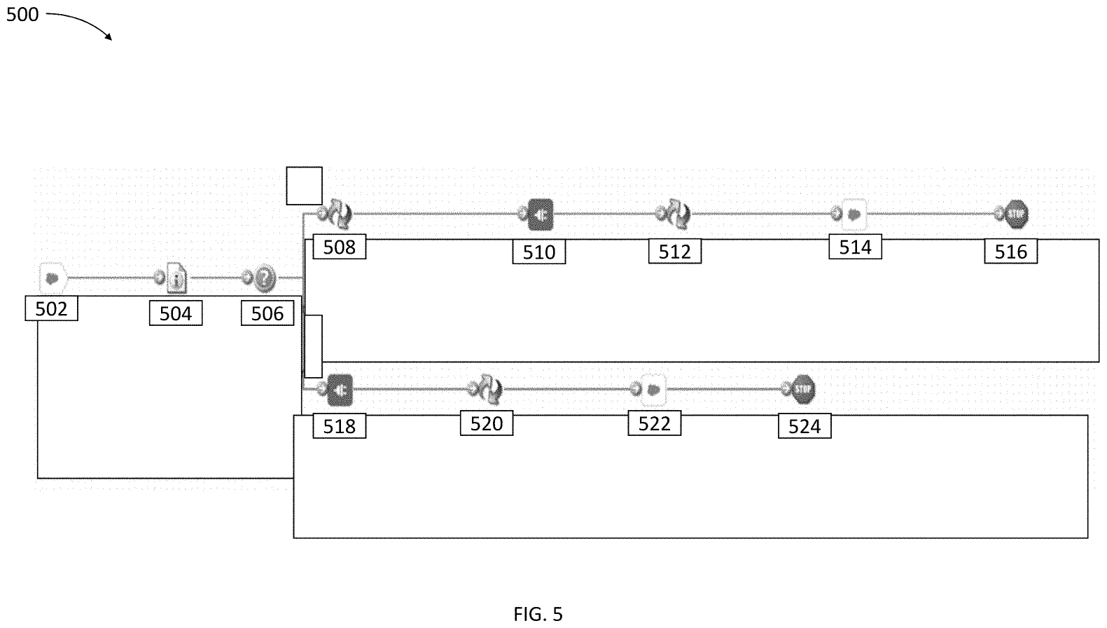

Any given user's profile has attributes of each of these types of metadata gleaned from each of the business integration processes represented to the user by the business integration application management system with an integration application development platform. Turning now to FIG. 5, a user profile may be developed, at least partially, by the integration application development platform user profiling module using the business integration process (e.g., user-generated flow diagram) shown. FIG. 5 is a graphical diagram illustrating a user-generated flow diagram 500 of a business integration process according to an embodiment of the present disclosure.

As described, the user's profile may include personal identification data such as the user's email address or other contact information, a time zone (geographic location) the user is physically located at, a perceived industry the user is creating business integration process for, the user's skills with the visual elements used, and the skill levels of the user as described herein. FIG. 5 shows a specific example of a user-generated flow diagram from which a user profile may be generated by the integration application development platform user profiling module.

The user-generated flow diagram 500 may begin with, in this example, input data being retrieved from an application via a connector or start visual element 502 such as the SalesForce's® CRM Platform visual element. This may include demonstrating the SalesForce's® connection, receiving a SalesForce's® case parameter to confirm process options for retrieving input datasets from a SalesForce® application environment that may be located, for example, at a trading partner. A step may be then made in the user-generated flow diagram 500 to a “set priorities” visual element 504. A step then passes the user-generated flow diagram 500 onto a “determination” visual element 506. In this example, the determination visual element 506 may determine whether a key exists. The result of the determination visual element 506 may lead to a “true” branch on the user-generated flow diagram or a “false” branch. The “true” branch is another step that leads to a “bug tracking” visual element 508, for example. A next step may lead to another application visual element such as a JIRA visual element 510 that may be used to track workflow of software development. A further step may be made to an updating visual element 512 so to, for example update a SalesForce® case with an issue key and link. A next step may lead to another instance of the SalesForce's® CRM Platform visual element 514 used to update the SalesForce's® case with the JIRA issue tracking for project management. The next step may lead to an end process visual element 516 where the processes of the user-generated flow diagram 500 end.

Where the “false” branch is followed, another step may lead to another application visual element such as a JIRA visual element 518. The next step may lead to updating visual element 520 so to, for example update a SalesForce® case with an issue key and link. A next step may lead to another instance of the SalesForce's® CRM Platform visual element 522 used to update the SalesForce's® case. The next step may lead to an end process visual element 524 where the processes of the user-generated flow diagram 500 ends.

The metadata obtained by an integration application development platform user profiling module from the user-generated flow diagram 500 may be specific to this user-generated flow diagram. For example, the user's personal contact information (e.g., email address) may be known via the use of login information used to access the business integration application management system with an integration application development platform, for example. The time zone or geographical location may be accessed based upon the IP address of the computing device used to access the business integration application management system with an integration application development platform.

Other metadata obtained from the creation of the user-generated flow diagram 500 may be more specific to the user's application skills, skill levels, and experiences in making user-generated flow diagrams for a specific industry. Again, a user may be using only a subset of the capabilities provided to them via the types of visual elements. For example, a user may be only using those visual elements in their user-generated flow diagrams as shown in FIG. 5. This allows the integration application development platform user profiling module to deduce that the user has skills in creating integration solutions that use those specific visual elements, such as JIRA based or SalesForce® based integrations, but not necessarily other types of visual elements. Additionally, the complexity of the arrangement of the visual elements or the complexity of the visual elements themselves may also be used by the integration application development platform user profiling module to determine the user's expertise in business integration process development. In FIG. 5, the number of different types of visual elements is 6 with a single distinct visual element being used multiple times.

The metadata may include metadata descriptive of the user's skill levels generally, in an embodiment. A skill level rating for a user may be based on one, a plurality, or all of the business integration processes developed by that user. The integration application development platform user profiling module may determine, for example, how may visual elements are used in each of the business integration processes. If a mean or average use of any specific visual element meets or exceeds a predetermined value, the integration application development platform user profiling module may deduce that the user is skilled at using that visual element. In a specific embodiment, this threshold value below 5 visual elements used within business integration processes may indicate a rating at beginning level. A threshold of 5 or above visual elements in business integration processes may indicate an intermediate level in some embodiments. A threshold of 8 visual elements in business integration processes may indicate an advanced level in some embodiments. It is understood that these thresholds are examples for illustration only and other threshold levels may also be implemented. Further, these threshold levels may be modified by complexity of business integration processes modeled such as involving many branches or parallel linked business integration processes or based on variety of visual elements or application types utilized across many developed business integration processes.

For example, in an embodiment, the skill level rating for the user may also or alternatively be based on the different types of visual elements within the business integration processes the integration application development platform user profiling module detects. If a mean or average use of different types of visual element meets or exceeds a predetermined value, the integration application development platform user profiling module may determine that the user is skilled at using one or more of those visual elements in a variety of business integration process contexts. In a specific embodiment, this threshold value varied uses is 10 different visual elements used in more than one integration environment may indicate an advanced skill level. Three different visual elements used in only similar integration environments may indicate a beginning skill level.

In an embodiment, the skill level rating for the user may also or alternatively be based on the number of steps used within the business integration process and detected by the integration application development platform user profiling module. The number of steps within the business integration process may be counted by counting the number of process lines present between any visual element represented in the user-generated flow diagrams 500. If a mean or average number of steps meets or exceeds a predetermined value, the integration application development platform user profiling module may determine that the user is at a skill level for using a particular visual element or a type of business integration process such as categorized similar to those identifiers for industry type, application type, connector type, or action of a connector as described in detail in FIG. 4. In a specific embodiment, this threshold value is 8 steps for an intermediate skill level. A threshold value of 4 steps may indicate a beginning level and a threshold value of 14 may indicate an advanced skill level.

Any threshold levels may be used with the above examples of determination of skill levels in various embodiments. Additionally, any number of skill levels may be defined although only beginning, intermediate, or advanced are described above. Moreover, any combination of example factors may be utilized by an integration application development platform user profiling module to assess a skill level for a user profile. For example, a combination of number of integration applications developed, a number of connectors or shapes used within modeled business integration processes, a variety of connectors or shapes used or application types managed, a number of steps or branches, or other aspects determined from examples of modeled business integrations by a user may be used or combined in various ways to meet threshold levels such as beginning skill level, intermediate skill level, advanced skill level, or additional granular skill levels according to embodiments herein.

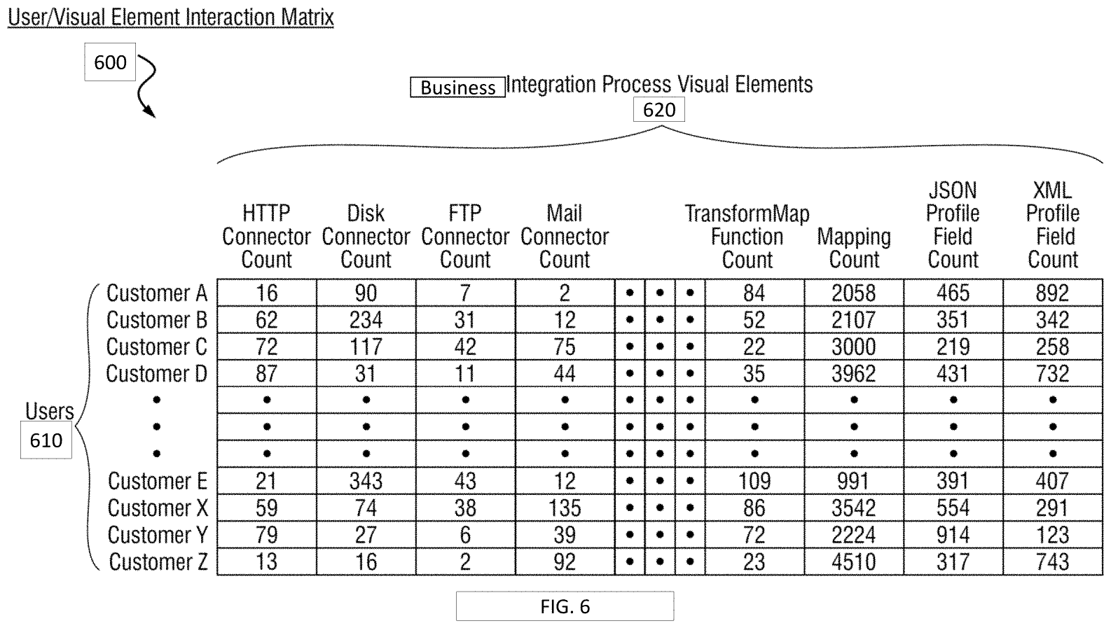

FIG. 6 is a graphical diagram illustrating a user/visual element interaction matrix according to an embodiment of the present disclosure. FIG. 6 is a graphical user interface for searching, displaying, and generating reports describing data model field values. In an example embodiment, data model field values may be tracked within a business integration process for purposes of tracking data fields labeled as sensitive information that are involved in an integration process. As described herein, upon request of an EU citizen whose personal data has been included within an integration process, an adherent to the GDPR (e.g., entity performing data integration processes) must provide adequate explanation of the ways in which such personal data has been manipulated or transferred. In addition, one way for an enterprise system executing data integration processes to protect against infringement involves tracking the content of data model field values being integrated, and the ways in which such data is being manipulated. Such tracking may occur, but may also be indicators of activity with the tracking of detailed metrics describing data affected by each integration process, information that was incorporated within such data, and the ways in which such data was accessed, copied, transferred, or otherwise manipulated in an infringing integration process. Such detailed information may indicate preventative and mitigating measures were taken with respect to sensitive data, but may also assist in providing data type inputs to determine integration application user profiles for users developing business integration processes.

FIG. 6 is a block diagram illustrating a user/visual element interaction matrix recording, per user 610, each implementation of a given visual element pursuant to an integration process according to an embodiment of the present disclosure. The user/visual element interaction matrix may be gathered from a plurality of integration application development platform operation logs for users of the business integration application management system and integration application development platform to model business integration processes. The integration application development platform community collaboration system, in an embodiment, may provide a more accurate method of forming each user's profile based on the user's expertise and skills in relation to their use of each available visual element. Several methods exist to accurately form each user's profile based on the user's expertise and skills in relation to their use of each available visual element mostly involving profiling based on a user's recorded or known use preferences for a plurality of that visual elements and associated features. For example, the variety of use the available visual elements as well as the frequency of the use of those visual elements may be used by the integration application development platform user profiling module to form a profile that either does or does not suggest that the user is an expert at implementing any specific visual element, forming relatively complex and complete user-generated flow diagrams, and overall experience in developing the plurality of user-generated flow diagrams.

In an embodiment, matrix factorization and, for example, deep learning via a neural network may provide a method of creating a user profile by the integration application development platform user profiling module. Such a method may allow the integration application development platform user profiling module to determine the number of visual elements used in the user-generated flow diagram for each user as well as the frequency of their use. Still further, the user's skills may be determined based on the complexity of each business integration process generated. Even further, the types of visual elements used as well as the types of fieldnames created or augmented by the user for tracking that may indicate the industry the user has generated the business integration process for.

In a specific method, the integration application development platform user profiling module may begin by generating a user/visual element interaction matrix 600 as shown in FIG. 6. The user/visual element interaction matrix 600 records all of the measured instances of use of any specific visual elements. This recordation may be completed over a given time period such as a month or a year. The user/visual element interaction matrix 600 shows a list of customers (e.g., users 610 of the business integration application management system with an integration application development platform and integration application development platform community collaboration system) relative to their use of each of the business integration process visual elements 620.

Taking an example from the user/visual element interaction matrix 600, Customer A may have a profile created by the integration application development platform user profiling module based upon, at least, the number of instances of use of each of the available business integration process visual elements 620. FIG. 6 shows that Customer A has used the HTTP Connector 16 times within one or more developed business integration processes; the Disk Connector 90 times within one or more developed business integration processes; the FTP Connector 7 times within one or more developed business integration processes; the Mail Connector 2 times within one or more developed business integration processes; the TransformMAP Function 84 times within one or more developed business integration processes; the Mapping 2058 times within one or more developed business integration processes; the JSON Profile Field 465 times within one or more developed business integration processes; and the XML Profile Field 892 times within one or more developed business integration processes. The user/visual element interaction matrix 600 also shows that there are additional business integration process visual elements 620 not shown on the user/visual element interaction matrix 600 but that may be made available to Customer A to develop business integration processes. It is also appreciated that there are some business integration process visual elements 620 that may not have been used by Customer A for any business integration process.

Following the data provided in the user/visual element interaction matrix 600 for Customer A, the integration application development platform user profiling module may then develop a user profile for Customer A that includes values assigned to define Customer A's experience level with the visual elements, Customer A's skill level in implementing one or a plurality of visual elements, Customer A's experience with regard to a specific industry, among other profiling data such as a time zone, geographical location, and contact information. The integration application development platform user profiling module may determine, for example, how many visual elements are used in each of the business integration processes as well as how many times each of the visual elements are used across all of the visual elements. If a mean or average use of any specific visual element meets or exceeds a predetermined value, the integration application development platform user profiling module may deduce that Customer A is skilled at using that visual element. In a specific embodiment, this threshold value is 20 uses will exceed a beginning skill level to an intermediate skill level. According to FIG.6, Customer A is skilled based on the determination that the average or mean number of times each visual element has been used (as shown) exceeds this threshold.

In an embodiment, the skill level rating for Customer A may also or alternatively be based on the different types of visual elements within the business integration processes the integration application development platform user profiling module detects. If a mean or average use of different types of visual element meets or exceeds a predetermined value, the integration application development platform user profiling module may deduce that Customer A is skilled at using that visual element. In a specific embodiment, this threshold value is 8 or more different visual elements used may indicate an intermediate skill level. According to FIG.6, Customer A may be skilled based on the determination that the number of different visual elements used by Customer A may have exceeded this threshold. It is said the Customer A may be skilled based on the diversity of visual elements used because not all of the potential visual elements made available to Customer A is shown in FIG. 6 and it may be that the number of different types of visual elements 620 may be equal to or greater than 10.

In an embodiment, the skill level rating for the user may also or alternatively be based on the number of steps used within the business integration process and detected by the integration application development platform user profiling module. The number of steps is not shown in FIG. 6. However, additional data may be presented on the user/visual element interaction matrix 600 to reflect the number of steps or average number of steps Customer A uses in his or her business integration processes. The number of steps within the business integration processes may be counted by counting the number of process lines present between any visual element as, for example, represented in the user-generated flow diagram. If a mean or average number of steps meets or exceeds a predetermined value, the integration application development platform user profiling module may deduce that Customer A is skilled at a certain level. In a specific embodiment, this threshold value is 8 steps may indicate that above this threshold a user has an intermediate skill level for example. Again, FIG. 6 does not show the average or mean number of steps between the various visual elements in the business integration process developed by Customer A. However, it is appreciated that this data may also be included in the user/visual element interaction matrix 600.

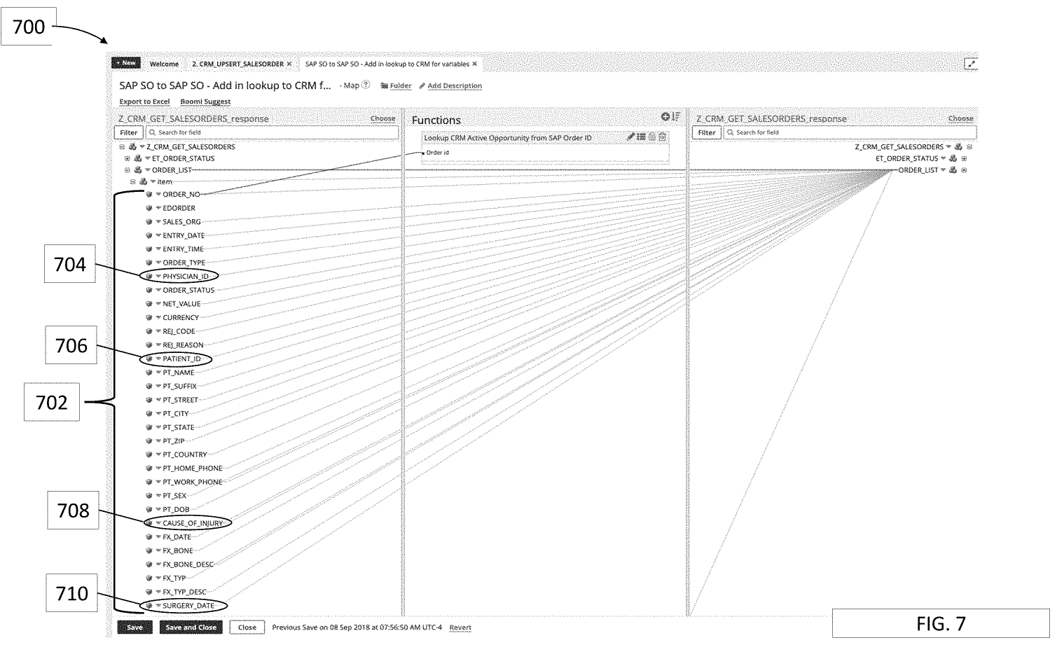

As mentioned, the visual elements may be associated with datasets that include user-defined data model fieldname, which may describe a type of information to be associated with the visual elements. Because these datasets are user-defined, the user's industry may be seen through the creation or augmentation of these datasets. FIG. 7 is a graphical diagram 700 illustrating a mapping from a mapping type visual element between multiple data model fieldnames 702 for a single data model field value for at least a portion of an integration process according to an embodiment of the present disclosure. The graphical diagram 700 may include a fieldname lineage map that can be displayed, in an embodiment, via a graphical user interface on a video display. A user may create, view, or edit a fieldname lineage map in an embodiment by selecting the “Manage” tab or other user-actuatable icon in an embodiment. An example fieldname lineage map in an embodiment may include a listing of one or more data model fieldnames 702 for data model field values accessed, transmitted, copied, or otherwise manipulated by a visual element as well as a listing of one or more data model fieldnames for data model field values accessed, transmitted, copied, or otherwise manipulated by, for example, another visual element. Labels of these fieldnames may also be made for tracking of sensitive information such as GDPR data or health related data.

Certain data model fieldnames 702 have been called out in FIG. 7 due to their industry-identifying characteristics. For example, a “Physician_ID” fieldname 704 has been indicated along with a “Patient_ID” fieldname 706, a “Cause_Of_Injury” fieldname 708, and a “Surgery_Date” fieldname 710. During operation, the integration application development platform user profiling module may review all augmented, created, accessed, manipulated, or copied visual element data model fieldnames 702 to determine whether the integration application development platform user profiling module can determine which industry the user is creating the business integration process to operate within. It is clear that, from the highlighted data model fieldnames 702 in FIG. 7, the integration application development platform user profiling module may easily deduce with a relatively high level of certainty that the user is developing the business integration process for use in the healthcare industry. The integration application development platform user profiling module may then indicate in the user's profile that, for this business integration process development at least, the user has created a business integration process associated with the healthcare industry. The integration application development platform user profiling module may complete this analysis for each of the business integration processes developed by the user and determine what percentages of developed business integration processes are likely used for which industries. The types of industries may include, for example, a manufacturing industry, a healthcare industry, a transportation industry, a shipping industry, a human resources industry, and a banking industry, among others.

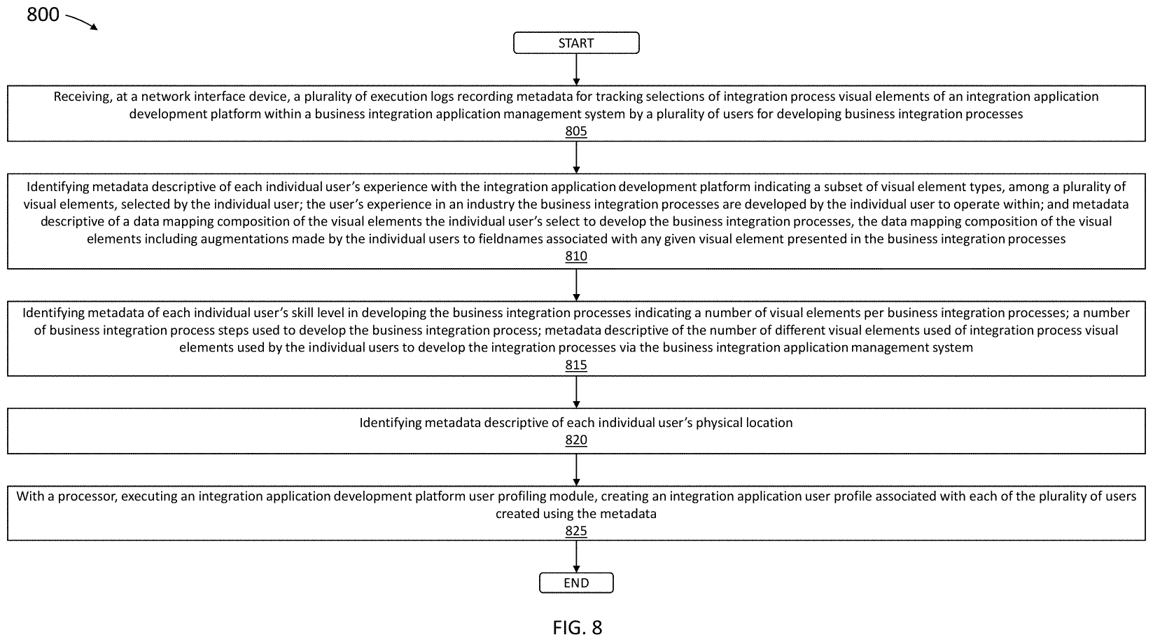

FIG. 8 is a flow diagram illustrating a method of creating an integration application user profile of a user of a business integration application management system according to an embodiment of the present disclosure. At block 805, the method 800 may include receiving, at a network interface device, a plurality of integration application development platform operation logs recording metadata for tracking selections of integration process visual elements of an integration application development platform for a plurality of users while developing business integration processes. The integration application development platform operation logs may be generated after a user has created a business integration process or as the user is creating a business integration process. The metadata may be specific to the user and stored by any system within the network for future consumption by, for example, an integration application development platform user profiling module. The metadata itself may be descriptive of any interaction the first user has had in connection with the use of a business integration application management system with an integration application development platform and the visual elements presented on a GUI by the business integration application management system with an integration application development platform.

The method may further include, at block 810, identifying metadata descriptive of each individual user's experience with the application development platform indicating a subset of visual element types, among a plurality of visual elements, selected by the individual user. As described herein, a GUI displayed via a display screen may provide a visual designer environment permitting a user to define process flows between applications/systems, such as between trading partner and enterprise systems, and to model a customized business integration process through the manipulation of specific visual elements. The visual elements are representative of a code set that is to be executed by a processor in order to manipulate, store, read, write, and transmit data through the business integration processes. The arrangement, use, and customization of these different types of visual elements helps to create metadata that indicates each individual user's experience with the application development platform. The variety and number of these visual elements used in one or a plurality of business integration processes is also used to create metadata describing the expertise and experience of each of the users of the application development platform. After determining values for all of the above of any given user's experience level, this metadata may be used by the integration application development platform user profiling module to determine a cumulative experience level for each user of the business integration application management system with an integration application development platform.

At block 810, metadata received from integration application development platform operation logs descriptive of each individual users' experience in an industry while developing the business integration processes. In some embodiments, the metadata descriptive of the users' experience in an industry may originate at certain user-modified, -augmented, or -created fieldnames associated with each visual element. For example, a “Physician ID” fieldname, a “Patient ID” fieldname, a “Cause Of Injury” fieldname, and a “Surgery Date” fieldname created, or modified by the user and associated with a specific visual element may indicate to the integration application development platform user profiling module that the user is creating or has created a business integration process associated with the healthcare industry. A search for these fieldnames may be conducted by the integration application development platform user profiling module to generate this type of metadata.

Still further, at block 810, metadata descriptive of a data mapping composition of the visual elements the individual user selects to develop the business integration processes may also be identified. In this embodiment, the data mapping composition of the visual elements may include a monitoring of augmentations made by the individual users to fieldnames associated with any given visual element presented in the business integration processes. As the number of fieldnames are augmented, the experiences of the user may be increased and the integration application development platform user profiling module may identify this additional experience.

The method 800 may include, at block 815, identifying metadata of each individual user's skill level in developing the business integration processes indicating a number of visual elements per business integration processes. As described herein, some users of the business integration application management system with an integration application development platform may use or may have only used a specific subset of visual elements (representative of visual elements of the integration process) provided or available to them by the business integration application management system. However, what visual elements are being used by the user, the integration application development platform user profiling module concludes that the user has skills associated with those particular visual elements. Further, in some embodiments, visual elements may be particular to or customized for interaction with particular application environments as described with respect to FIG. 4. The type of application may indicate an experience level for interactions with such applications or developing business integrations between one or more of these application types.

Additionally, at block 815, an identification of a number of business integration process steps used to develop the business integration process is conducted. As described herein, as the visual elements are placed within the GUI, the complexity of the business integration process may increase due to the interaction between the visual elements as well as the number of branches formed in the business integration process. This increases the number of steps within the business integration process which indicates the user's skills in creating effective interactions between the visual elements.

Still further, at block 815, and identification of metadata descriptive of the number of different visual elements used of integration process visual elements used by the individual users to develop the integration processes is conducted. Again, as the user is able to increase the number of different visual elements used, the user increases his or her skills based on the ability to operatively couple the number of visual elements to operate the business integration processes.

At block 820, the method 800 may include identifying metadata descriptive of each individual user's physical location. In a specific embodiment, the metadata associated with the users' physical location may be obtained by accessing an internet protocol (IP) address of each user. In this embodiment, the users' may be accessing the business integration application management system with an integration application development platform via a browser at, for example, the information handling system acting as a server system. The metadata associated with the geographic location of the user may be used by the integration application development platform user profiling module to define, for example, a perceived language of the user. Although this is not dispositive of the language a user may speak, this metadata may be used by the integration application development platform community collaboration system to better match users who speak or could speak the same language.

The method 800 at block 825, may also include, with a processor executing an integration application development platform user profiling module, creating an integration application user profile associated with each of the plurality of users created using the metadata. The various types of metadata may be input into a deep learning neural network system or into one or more machine learning classifiers trained to determine classifications related to fields to be determined within the integration application user profile. The integration application user profile may have fields such as industry experience types, application experience types, visual element experience types, locations, skill levels or other entries that may be populated by operation of one or more deep learning neural networks or machine learning classifiers. Additionally, contact information for users may be associated with or included with an integration application user profile. Thus, upon conclusion of the operation of a deep learning neural network, one or more machine learning classifiers, or another type of supervised learning artificial intelligence suitable to populate user profile fields, the integration application user profile module may generate a user profile for a user to be stored at a service provider or an enterprise location in various embodiments. The integration application user profile may reflect each of the experiences the users' have had with the visual elements, the skill level the users' implementation and arrangement of the visual elements, the users' experience in using the visual elements in an industry, and the time zone or physical location of the user. As described herein, this user profile created for each user may be used to match users together on an integration application development platform community collaboration system to address a query from the any user with access to the integration application development platform community collaboration system as described herein.

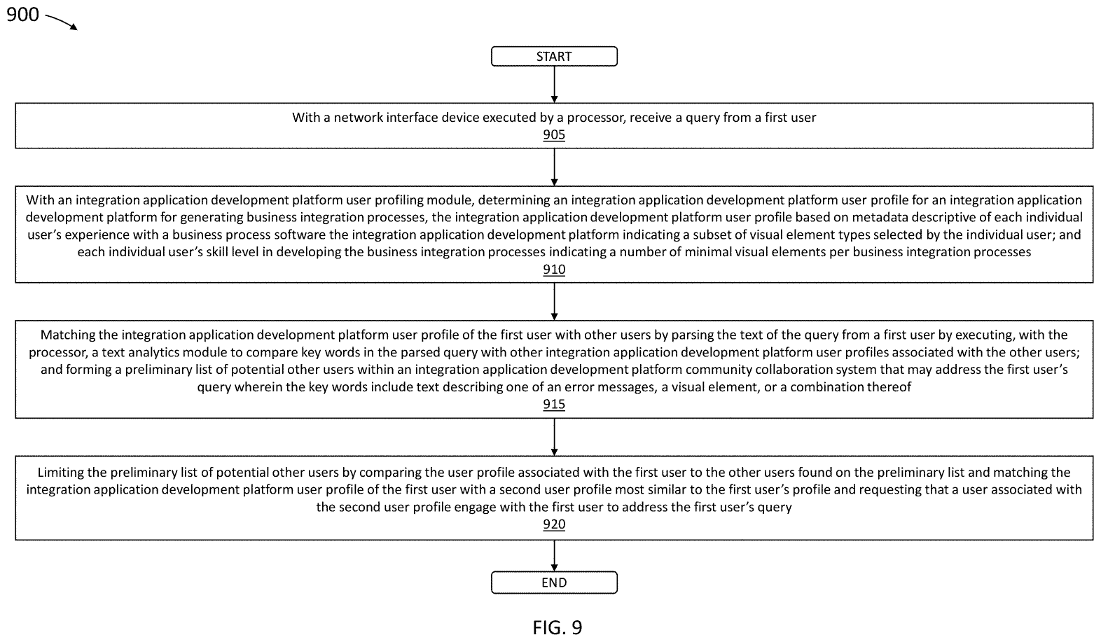

FIG. 9 is a flow diagram illustrating a method 900 of connecting a first user with another user within an integration application development platform community collaboration system according to an embodiment of the present disclosure. As described in connection with FIG. 8, each user of a business integration application management system with an integration application development platform has a user profile created and assigned to him or her. The method 900 may begin with, at a network interface device executed by a processor, receiving a query from a first user at block 905. The query may include any question the first user may have in operating the business integration application management system with an integration application development platform and interacting with the creation of the business integration process via the GUI and visual elements. The query, in a specific embodiment is presented on a forum associated with the integration application development platform community collaboration system.

The method 900 proceeds at block 910 with determining with an integration application development platform user profiling module an integration application user profile for a user of an integration application development platform for generating business integration processes. Here, the integration application user profile is based on the metadata descriptive of each individual user's experience with a business integration application management system with an integration application development platform the application development platform indicating a subset of visual element types selected by the individual user as described herein and specifically in FIG. 9. Additionally, the integration application user profile is based on the metadata descriptive of each individual user's skill level in developing the business integration processes indicating a number of minimal visual elements per business integration processes. Again, obtaining of the skill level of the users based on metadata obtained from the user's interaction with the business integration application management system with an integration application development platform has been described in several embodiments herein. Additionally, the integration application user profile may indicate an industry type, a geographic location, application environment experience, or other aspects useful to group users based on integration application user entry fields.

The method may continue at block 915 with matching the integration application user profile of the first user with other users. In this embodiment, this may be done by parsing the text of the query from a first user via the execution of an intelligent text analytics module to compare key words in the parsed query with other integration application user profiles associated with the other users. The text analytics module may be executed by a processor associated with the business integration application management system with an integration application development platform or a processor executing code instructions of integration application development platform community collaboration system for example. The result of block 915 results in the formation of a preliminary list of potential other users within an integration application development platform community collaboration system that may address the first user's query. The text analytics module has created this list by identifying, in a specific embodiment, key words that include text describing one of an error messages, a visual element, or a combination thereof. For example, text in the query from the first user may be cross-referenced with any number of user profiles and the metadata developed and discovered by the integration application development platform user profiling module in order to determine which of any other user has had any experience with similar applications, similar industries, or similar visual elements. Still further, the text parsed within the query from the first user may indicate that an error message was generated when the user had attempted to develop, update, or test a business integration process. This error message may include certain text or even an error message code that other users had seen during their development, updating, or testing of their own business integration processes. In this specific example embodiment, the parsed error text or code may be used by the integration application development platform community collaboration system to, alternatively or additionally, match other users' profiles to the error text or code in first user's query or an error message received by the first user.

The matching process described in connection with block 915 creates a preliminary list of potential users that can address the first user's query. The number of users presented on the preliminary list may be further reduced using another matching process. In this embodiment, the method 900 may continue at block 920 with limiting this preliminary list of potential other users by comparing the user profile associated with the first user to the other users found on the preliminary list and matching fields within the integration application user profile of the first user with a second user profile most similar to the first user's profile. For example, geographic location, industry, or application types may be matched to provide a second user profile or group of similarly situated user profiles that may serve as match to the first user with the query.

As described herein, each user profile may reflect an industry, a time zone, and/or a language of the user. In an embodiment, this information on the first user's profile may limit the potential other users on that preliminary list. Still further, in some embodiments, the first user may need help from another user that is relatively more experienced and skilled with interfacing with certain visual elements. Indeed, it may be best to pass on experience and skills to those users such as the first user that may need gain the experience and skills. As such, the final list of potential users who could address the first user's query may be ranked with the most experienced user at the top of the final list or the list may include users only with an experience level above the skill level of the first user. It may be appreciated that every integration application development platform user has a specific set of skills based on the technologies they have experience with, and likely possesses skills for certain industries based on their technical and job experiences. Similarly, these same integration application development platform user may lack specific set of skills and likely a lack those skills within certain industries based on a lack of experience in these areas. The integration application development platform community collaboration system allows for the sharing of skills and expertise to those who lack them. A user may have multiple skill levels which relate differently among identified industry sectors, for particular application environments, or with particular connector types in business integration development in various embodiments.

The method 900 may be followed up at block 920 with requesting that a user associated with the second user profile engage with the first user to address the first user's query. As mentioned, the final list of users may include a ranked list of users with, in this example, the second user's profile being on a final list. Such a list may for example be a grouping of similar users based on integration application user profiles indicating similar experience using the integration application development platform. Similarities or groupings on a list of users may be based skill levels as well as on several other factors including industry sector identified, types of visual element connectors utilized, geographic locations, or other information generated in the integration application user profile of various users. The integration application development platform community collaboration system may send a specific message via the integration application development platform community collaboration system or other electronic communication form to this second user to request the second user to address the first user's query. In some embodiments, this message may be sent via IM, email or as another form of direct message on the forum associated with the integration application development platform community collaboration system. In a specific embodiment, the second user may decline to respond. In such a scenario, the integration application development platform community collaboration system may send a new message to another user on the final list asking for a response to the first user's inquiry. This may continue until all users on the final list have been sent a message. In some cases, a service provider user may be present or monitoring a forum on the integration application development platform community collaboration system to be able to provide a response. Alternatively, the integration application development platform community collaboration system may “shotgun” a message to multiple users on the final list and each user may individually engage with the first user and his or her query over a forum. In this way, the first user may increase his or her knowledge in interacting with the business integration application management system with an integration application development platform thereby increasing the quality and quantity of business integration processes produced by the business integration application management system with an integration application development platform.

The blocks of the flow diagrams 8 and 9 discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram. Further, those of skill will understand that additional blocks or steps, or alternative blocks or steps may occur within the flow diagrams discussed for the algorithms above.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating an integration application development platform user profiling module comprising:
a processor;
a memory;
a network interface device receiving a plurality of integration application development platform operation logs recording metadata for tracking selections of integration process visual elements of an integration application development platform by a plurality of users for developing business integration processes; and
an integration application development platform user profiling module to, upon execution by the processor, create an integration application user profile associated with each of the plurality of users created using the metadata;
wherein each of the integration application user profiles are created based on metadata descriptive of:
each individual user's experience with the integration application development platform indicating visual element types selected by the individual user or an industry in which a business integration process operates; and
each individual user's skill level in developing the business integration processes indicating a number of minimal visual elements per business integration process.

2. The information handling system of claim 1, further comprising metadata descriptive of each user's experience in the industry in which the business integration processes operates determined from data set fields descriptive of data sets transformed in the business integration process.

3. The information handling system of claim 1, wherein the metadata descriptive of the individual users' experience with the integration application development platform further comprises metadata indicating a subset of visual element types selected by the individual user, among a plurality of different visual element types, to develop the business integration processes.

4. The information handling system of claim 1, wherein the metadata descriptive of the individual user's experience with the application development platform further includes metadata descriptive of a data mapping composition of the visual elements the individual user's select to develop the integration processes, the data mapping composition of the visual elements including augmentations made by the individual users to fieldnames associated with any given visual element presented in the business integration processes.

5. The information handling system of claim 1, wherein the metadata descriptive of the individual user's skill level further includes a number of business integration process steps used to develop the business integration process.

6. The information handling system of claim 1, further comprising:
metadata descriptive of the individual user's skill level that includes metadata descriptive of the number of different integration process visual elements used by the individual users to develop the integration processes.

7. The information handling system of claim 1, further comprising:
wherein the metadata includes metadata descriptive of the individual user's experience in an industry determined from keywords in the metadata descriptive of the integration process visual elements or data field labels used by the individual users to develop the business integration processes.

8. The information handling system of claim 1, further comprising:
metadata descriptive of each individual user's physical location.

9. The information handling system of claim 1, further comprising:
the processor to notify at least one individual user of the plurality of users, via an integration application development platform community collaboration system, that a second individual user has initiated a business integration process question the at least one individual user has experience with based on the profile of the at least one individual user.

10. The information handling system of claim 1 further comprising:
the integration application development platform executing code instructions for a graphical user interface for displaying the selection and creation of the business integration process visual elements of the developed business integration process by the individual user.

11. A computer implemented method of creating an integration application user profile of users of an integration application development platform for developing business integration processes, comprising:
receiving, at a network interface device, a plurality of integration application development platform operation logs recording metadata for tracking selections of integration process visual elements in an application development platform by a plurality of users for developing integration processes;
with a processor executing an integration application development platform user profiling module, creating an integration application user profile associated with each of the plurality of users created using the metadata;
creating each of the integration application user profiles based on metadata descriptive of:
each individual user's experience with the integration application development platform indicating a subset of visual element types selected by the individual user, the metadata for each individual user's experience used to group similar users;
each individual user's skill level in developing the business integration processes indicating a number of minimal visual elements per business integration processes; and
matching the integration application user profile of a first user with other users within an integration application development platform community collaboration system.

12. The method of claim 11 wherein metadata descriptive of each individual user's experience with the integration application development platform for grouping with similar users includes metadata descriptive of each individual user's experience in an industry the business integration processes are developed by the individual user to operate within for the integration application user profiles.

13. The method of claim 11, wherein the metadata descriptive each individual user's skill level in developing the business integration processes indicates a number of different visual element types selected by the individual user to develop the business integration processes from a plurality of available different visual element types.

14. The method of claim 11, wherein the metadata descriptive of the individual user's skill level in developing the business integration processes further includes metadata descriptive of a data mapping composition of the visual elements selected by the individual user to develop the integration processes, the data mapping composition of the visual elements including augmentations made by the individual users to fieldnames associated with any given visual element presented in the business integration processes.

15. The method of claim 11, wherein the metadata descriptive of the individual user's skill level further includes a number of business integration process steps used to develop the business integration process.

16. The method of claim 11, wherein metadata descriptive of each individual user's experience with the integration application development platform for grouping with similar users includes metadata descriptive of geographic location.

17. The method of claim 11, further comprising:
receiving a notification at the network interface device a question from the first user indicative of a request for help regarding a business integration process under development; and
forwarding the question to a second user in the application developing platform community collaboration system to answer the question of the first user based on a level of similarities to indicate grouping between a first user application development platform profile assigned to a first user and a second integration application user profile assigned to the second user.

18. An information handling system operating an integration application development platform user profiling module comprising:
a processor;
a memory;
a graphical user interface;
a network interface device receiving a query from the first user; and
an integration application development platform user profiling module to determine an integration application user profile for users of an integration application development platform for generating business integration processes, the integration application user profile based on metadata descriptive of:
each individual user's experience with a business integration application management system with the integration application development platform based on indications of a subset of visual element types selected by each individual user, the metadata for each individual user's experience used to group similar users; and
each individual user's skill level in developing the business integration processes indicating a number of visual elements per business integration processes developed by a user; and
matching the integration application user profile of the first user with other users within an integration application development platform community collaboration system based on similarity of each individual user's experience and a higher user skill level above the first user.

19. The information handling system of claim 18, wherein matching the integration application user profile of the first user with other users further comprises:
the processor parsing the text of the query from a first user;
the processor executing a text analytics module to compare key words in the parsed query with other integration application user profiles associated with the other users; and
the processor forming a preliminary list of potential other users within an integration application development platform community collaboration system that may address the first user's query, wherein the key words include text describing one of an error messages, a visual element, or a combination thereof

20. The information handling system of claim 19, wherein matching the integration application user profile of the first user with other users further comprises further limiting the preliminary list of potential other users by:
the processor comparing the user profile associated with the first user to the other users found on the preliminary list and matching the integration application user profile of the first user with a second user profile most similar to the first user's profile based on type of visual elements used or an industry sector in which a business integration process is used; and
a network interface device transmitting a request that a user associated with the second user profile engage with the first user to address the first user's query.
